(19) United States
(12) Patent Application Publication
(10) Pub. No.: US 2025/0382455 A1
(43) Pub. Date: Dec. 18, 2025

(54) RESIN COMPOSITION, PREPREG, FILM WITH RESIN, METAL FOIL WITH RESIN, METAL-CLAD LAMINATE, AND WIRING BOARD

(71) Applicant: PANASONIC INTELLECTUAL PROPERTY MANAGEMENT CO., LTD., Osaka (JP)

(72) Inventors: Hajime OGUSHI, Fukushima (JP); Hiroyuki FUJISAWA, Fukushima (JP); Koichi ISAJI, Osaka (JP)

(73) Assignee: PANASONIC INTELLECTUAL PROPERTY MANAGEMENT CO., LTD., Osaka (JP)

(21) Appl. No.: 18/995,482

(22) PCT Filed: Jul. 10, 2023
(86) PCT No.: PCT/JP2023/025508

§ 371 Date: Jan. 16, 2025

(30) Foreign Application Priority Data
Jul. 20, 2022 (JP) 2022-115730

(51) Int. Cl. C08L 71/12; C08J 5/04; C08K 3/36; C08K 5/3415; C08K 5/357; C08K 7/18; C08K 9/06

(52) U.S. Cl. CPC C08L 71/126; C08J 5/043; C08K 3/36; C08K 5/3415; C08K 5/357; C08K 7/18; C08K 9/06; C08L 2203/16; C08L 2203/20

(57) ABSTRACT

A resin composition that contains a preliminary reaction product (A) obtained by previously reacting a polyphenylene ether compound (a1) having a hydroxyl group in the molecule and an acid anhydride (a2) having an acid anhydride group in the molecule, a benzoxazine compound (B) having an alkenyl group in the molecule, and a reactive compound (C) having an unsaturated double bond in the molecule.

### TECHNICAL FIELD

The present invention relates to a resin composition, a prepreg, a film with resin, a metal foil with resin, a metal-clad laminate, and a wiring board.

### BACKGROUND ART

In various electronic devices, mounting technologies such as higher integration of semiconductor devices to be mounted, higher wiring density, and multi-layering have rapidly progressed along with an increase in the amount of information processed. In addition, wiring boards used in various electronic devices are required to be, for example, high-frequency compatible wiring boards such as a millimeter-wave radar board for in-vehicle use. Substrate materials for forming insulating layers of wiring boards used in various electronic devices are required to have a low dielectric constant and a low dielectric loss tangent in order to increase the signal transmission speed and to decrease the signal transmission loss.

It is known that polyphenylene ether exhibits excellent low dielectric properties such as a low relative dielectric constant and a low dielectric loss tangent and exhibits excellent low dielectric properties such as a low relative dielectric constant and a low dielectric loss tangent in a high frequency band (high frequency region) from the MHz band to the GHz band as well. For this reason, it has been investigated that polyphenylene ether is used, for example, as a high frequency molding material. More specifically, polyphenylene ether is preferably used as a substrate material for forming an insulating layer of a wiring board to be equipped in an electronic device utilizing a high frequency band. Examples of substrate materials containing polyphenylene ether include the resin composition described in Patent Literature 1.

Patent Literature 1 describes a curable resin composition containing a reaction product of polyphenylene ether with an unsaturated carboxylic acid or an acid anhydride, triallyl cyanurate, and a brominated aromatic compound containing at least one imide ring. Patent Literature 1 discloses that a polyphenylene ether-based resin composition that retains the excellent dielectric properties of polyphenylene ether and exhibits excellent flame retardancy, chemical resistance, and heat resistance after curing.

Substrate materials for forming insulating layers of wiring boards are required to afford cured products, which are excellent not only in low dielectric properties but also in heat resistance, adhesive properties to metal foils, and desmear properties and have a high glass transition temperature.

### CITATION LIST

### Patent Literature

Patent Literature 1: JP H7-166049 A

### SUMMARY OF INVENTION

The present invention has been made in view of such circumstances, and an object thereof is to provide a resin composition affording a cured product, which is excellent in low dielectric properties, heat resistance, adhesive properties to a metal foil, and desmear properties and has a high glass transition temperature. Another object of the present invention is to provide a prepreg, a film with resin, a metal foil with resin, a metal-clad laminate, and a wiring board, which are obtained using the resin composition.

An aspect of the present invention is a resin composition that contains a preliminary reaction product (A) obtained by previously reacting a mixture containing a polyphenylene ether compound (a1) having a hydroxyl group in the molecule and an acid anhydride (a2) having an acid anhydride group in the molecule, a benzoxazine compound (B) having an alkenyl group in the molecule, and a reactive compound (C) having an unsaturated double bond in the molecule.

The object described above and other objects, features and advantages of the present invention will become apparent from the following detailed description and accompanying drawings.

### BRIEF DESCRIPTION OF DRAWINGS

FIG. 1 is a schematic sectional view illustrating an example of a prepreg according to an embodiment of the present invention.

FIG. 2 is a schematic sectional view illustrating an example of a metal-clad laminate according to an embodiment of the present invention.

FIG. 3 is a schematic sectional view illustrating an example of a wiring board according to an embodiment of the present invention.

FIG. 4 is a schematic sectional view illustrating an example of a metal foil with resin according to an embodiment of the present invention.

FIG. 5 is a schematic sectional view illustrating an example of a film with resin according to an embodiment of the present invention.

### DESCRIPTION OF EMBODIMENTS

Metal-clad laminates and metal foils with resin used in the manufacture of wiring boards and the like include not only an insulating layer but also a metal foil on the insulating layer. Wiring boards also include not only an insulating layer but also wiring on the insulating layer. Examples of the wiring include wiring derived from a metal foil equipped in the metal-clad laminate or the like.

In electronic equipment, particularly in small portable devices such as portable communication terminals and notebook computers, diversification, improvement in performance, thinning, and miniaturization have rapidly proceeded. Along with this, in wiring boards used in these products as well, there is a further demand for refinement of conductor wiring, multilayering of conductor wiring layers, thinning, and improvement in performance such as mechanical properties. For this reason, in the wiring boards, it is required that the wirings do not peel off from the insulating layers although provided wirings are refined wirings. In order to meet this requirement, in the wiring boards, it is required that the adhesive properties between wirings and insulating layers are high. Hence, it is required that the adhesive properties between metal foils and insulating layers are high in metal-clad laminates, and substrate materials for forming insulating layers of wiring boards are required to afford cured products exhibiting excellent adhesive properties to metal foils.

Insulating layers of wiring boards used in various electronic devices are also required to have a property that smears generated by the drilling can be properly removed when drilling is performed using a drill, laser, or the like. Specifically, insulating layers of wiring boards are required to have a property (excellent desmear properties) that smears can be properly removed with permanganic acid or the like while damage to the insulating layers of wiring boards is suppressed. Hence, substrate materials for forming insulating layers of wiring boards are required to afford cured products exhibiting excellent desmear properties.

Wiring boards used in various electronic devices are also required to be hardly affected by changes in the external environment. For example, the wiring boards are required to exhibit excellent heat resistance so as to be used in environments having relatively high temperatures as well. Hence, substrate materials for forming insulating layers of the wiring boards are required to afford cured products exhibiting excellent heat resistance. Substrate materials for forming insulating layers of the wiring boards are required to afford cured products having high glass transition temperatures in order to obtain wiring boards exhibiting excellent reliability in a wide temperature range as well.

As a result of extensive studies, the present inventors have found out that the objects such as providing a resin composition that affords a cured product, which is excellent in low dielectric properties, heat resistance, adhesive properties to a metal foil, and desmear properties and has a high glass transition temperature, are achieved by the present invention below.

Hereinafter, embodiments according to the present invention will be described, but the present invention is not limited thereto.

### [Resin Composition]

The resin composition according to an embodiment of the present invention is a resin composition that contains a preliminary reaction product (A) obtained by previously reacting a mixture containing a polyphenylene ether compound (a1) having a hydroxyl group in the molecule and an acid anhydride (a2) having an acid anhydride group in the molecule, a benzoxazine compound (B) having an alkenyl group in the molecule, and a reactive compound (C) having an unsaturated double bond in the molecule. By being cured, the resin composition affords a cured product, which is excellent in low dielectric properties, heat resistance, adhesive properties to a metal foil, and desmear properties and has a high glass transition temperature.

As the preliminary reaction product (A) obtained by previously reacting a mixture containing the polyphenylene ether compound (a1) and the acid anhydride (a2) is cured together with the benzoxazine compound (B) and the reactive compound (C), it is considered that the resin composition can be suitably cured, and a cured product is obtained which has a high glass transition temperature and is excellent in heat resistance and adhesive properties to a metal foil while maintaining the excellent low dielectric properties of the polyphenylene ether chain in the polyphenylene ether compound (a1). When the resin composition contains the acid anhydride (a2), it is considered that the obtained cured product is likely to undergo desmear. Furthermore, when the resin composition contains the acid anhydride (a2), it is considered that the glass transition temperature of the obtained cured product also increases. On the other hand, when the acid anhydride (a2) is present in the resin composition, the cured product of the resin composition tends to exhibit decreased adhesive properties to a metal foil. By previously reacting the acid anhydride (a2) with the polyphenylene ether compound (a1) in the resin composition, it is considered that the acid anhydride (a2) is less likely to be volatilized and is likely to be retained in the resin composition. Furthermore, as the acid anhydride (a2) has reacted with the polyphenylene ether compound (a1), the decrease in adhesive properties to a metal foil due to the presence of the acid anhydride (a2) can be suppressed. From these facts, it is considered that it is possible to favorably exert the action by the acid anhydride (a2), for example, the action that the cured product is likely to undergo desmear or the glass transition temperature of the cured product increases while suppressing the decrease in adhesive properties to a metal foil. From these facts, it is considered that the resin composition affords a cured product, which is excellent in low dielectric properties, heat resistance, adhesive properties to a metal foil, and desmear properties and has a high glass transition temperature.

### (Preliminary Reaction Product (A))

The preliminary reaction product (A) is not particularly limited as long as it is a preliminary reaction product obtained by previously reacting a mixture containing a polyphenylene ether compound (a1) having a hydroxyl group in the molecule and an acid anhydride (a2) having an acid anhydride group in the molecule. The preliminary reaction product (A) is, for example, only required to be obtained by previously reacting the polyphenylene ether compound (a1) and the acid anhydride (a2), and may be a reaction product obtained by also previously reacting a compound (another raw material) (a3) capable of reacting with at least either of the polyphenylene ether compound (a1) or the acid anhydride (a2). In other words, examples of the preliminary reaction product (A) include a reaction product (A1) obtained by reacting the polyphenylene ether compound (a1) with the acid anhydride (a2) and a reaction product (A2) obtained by reacting the polyphenylene ether compound (a1) with the acid anhydride (a2) and the other raw material (a3). The mixture is only required to contain the polyphenylene ether compound (a1) and the acid anhydride (a2), and may further contain the other raw material (a3). The preliminary reaction product (A) is capable of reacting with the benzoxazine compound (B) and the reactive compound (C). The resin composition is cured as the preliminary reaction product (A) reacts with the benzoxazine compound (B) and the reactive compound (C). The resin composition is only required to contain at least either of the reaction product (A1) obtained by reacting the polyphenylene ether compound (a1) with the acid anhydride (a2) or the reaction product (A2) obtained by reacting the polyphenylene ether compound (a1) with the acid anhydride (a2) and the other raw material (a3) as the preliminary reaction product (A). The resin composition may contain the unreacted polyphenylene ether compound (a1), the unreacted acid anhydride (a2), or the unreacted other raw material (a3). The resin composition contains the reaction product [at least either of the reaction product (A1) or the reaction product (A2)] as the preliminary reaction product (A), and may further contain the polyphenylene ether compound (a1) and the acid anhydride (a2). The resin composition may contain the other raw material (a3). The other raw material (a3) is not particularly limited as long as it is a compound capable of reacting with at least either of the polyphenylene ether compound (a1) or the acid anhydride (a2).

(Polyphenylene Ether Compound (a1))

The polyphenylene ether compound (a1) is not particularly limited as long as it is a polyphenylene ether compound having a hydroxyl group in the molecule. The polyphenylene ether compound (a1) has a polyphenylene ether chain in the molecule and preferably has, for example, a repeating unit represented by the following Formula (1) in the molecule.

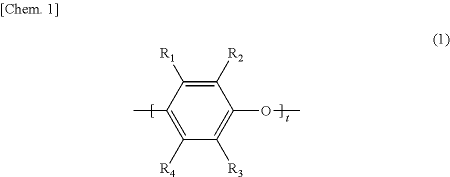

In Formula (1), t represents 1 to 50. R₁ to R₄ are independent of each other. In other words, R₁ to R₄ may be the same group as or different groups from each other. R₁ to R₄ represent a hydrogen atom, an alkyl group, an alkenyl group, an alkynyl group, a formyl group, an alkylcarbonyl group, an alkenylcarbonyl group, or an alkynylcarbonyl group. Among these, a hydrogen atom and an alkyl group are preferable.

Specific examples of the respective functional groups mentioned in R₁ to R₄ include the following.

The alkyl group is not particularly limited and is, for example, preferably an alkyl group having 1 to 18 carbon atoms and more preferably an alkyl group having 1 to 10 carbon atoms. Specific examples thereof include a methyl group, an ethyl group, a propyl group, a hexyl group, and a decyl group.

The alkenyl group is not particularly limited and is, for example, preferably an alkenyl group having 2 to 18 carbon atoms and more preferably an alkenyl group having 2 to 10 carbon atoms. Specific examples thereof include a vinyl group, an allyl group, and a 3-butenyl group.

The alkynyl group is not particularly limited and is, for example, preferably an alkynyl group having 2 to 18 carbon atoms and more preferably an alkynyl group having 2 to 10 carbon atoms. Specific examples thereof include an ethynyl group and a prop-2-yn-1-yl group (propargyl group).

The alkylcarbonyl group is not particularly limited as long as it is a carbonyl group substituted with an alkyl group and is, for example, preferably an alkylcarbonyl group having 2 to 18 carbon atoms and more preferably an alkylcarbonyl group having 2 to 10 carbon atoms. Specific examples thereof include an acetyl group, a propionyl group, a butyryl group, an isobutyryl group, a pivaloyl group, a hexanoyl group, an octanoyl group, and a cyclohexylcarbonyl group.

The alkenylcarbonyl group is not particularly limited as long as it is a carbonyl group substituted with an alkenyl group and is, for example, preferably an alkenylcarbonyl group having 3 to 18 carbon atoms and more preferably an alkenylcarbonyl group having 3 to 10 carbon atoms. Specific examples thereof include an acryloyl group, a methacryloyl group, and a crotonoyl group.

The alkynylcarbonyl group is not particularly limited as long as it is a carbonyl group substituted with an alkynyl group and is, for example, preferably an alkynylcarbonyl group having 3 to 18 carbon atoms and more preferably an alkynylcarbonyl group having 3 to 10 carbon atoms. Specific examples thereof include a propioloyl group.

The weight average molecular weight (Mw) and number average molecular weight (Mn) of the polyphenylene ether compound (a1) are not particularly limited, and for example, are preferably 500 to 5,000, more preferably 800 to 4,000, still more preferably 1,000 to 3,000. When the molecular weight is too low, sufficient heat resistance of the cured product tends to be hardly attained. When the molecular weight is too high, there is a tendency that the melt viscosity of the resin composition is high, sufficient fluidity is not attained, and molding defects cannot be sufficiently suppressed. Hence, when the weight average molecular weight of the polyphenylene ether compound is in the above range, excellent heat resistance and moldability of the cured product can be realized. Here, the weight average molecular weight and number average molecular weight may be those measured by general molecular weight measurement methods, and specific examples thereof include values measured by gel permeation chromatography (GPC). In a case where the polyphenylene ether compound has a repeating unit represented by Formula (1) in the molecule, t is preferably a numerical value so that the weight average molecular weight and number average molecular weight of the polyphenylene ether compound is in the above range. Specifically, t is preferably 1 to 50.

The average number of hydroxyl groups (number of hydroxyl groups) in the polyphenylene ether compound (a1) is not particularly limited, and is, for example, preferably 1 to 5, more preferably 1.5 to 3. When the number of hydroxyl groups is too small, it is difficult for the polyphenylene ether compound (a1) to react with the acid anhydride (a2), the reactivity of the preliminary reaction product obtained by reacting the polyphenylene ether compound (a1) with the acid anhydride (a2) with the benzoxazine compound (B) and the reactivity of the preliminary reaction product with the reactive compound (C) decrease, and sufficient heat resistance of the cured product tends to be hardly attained. When the number of hydroxyl groups is too large, the reactivity of the polyphenylene ether compound (a1) with the acid anhydride (a2) is too high, the reactivity of the preliminary reaction product (A) obtained by reacting the polyphenylene ether compound (a1) with the acid anhydride (a2) with the benzoxazine compound (B) and the reactivity of the preliminary reaction product with the reactive compound (C) are too high, and for example, the storage stability of the resin composition may decrease.

The number of hydroxyl groups in the polyphenylene ether compound can be found, for example, from the product standard value of the polyphenylene ether compound used. Specific examples of the number of hydroxyl groups here include a numerical value representing the average value of hydroxyl groups per 1 molecule of all polyphenylene ether compounds present in 1 mole of polyphenylene ether compound.

The intrinsic viscosity of the polyphenylene ether compound (a1) is not particularly limited, and is, for example, preferably 0.03 to 0.12 dl/g, more preferably 0.04 to 0.11 dl/g, still more preferably 0.06 to 0.095 dl/g. When the intrinsic viscosity is too low, the molecular weight tends to be low, and sufficient heat resistance of the cured product tends to be hardly attained. When the intrinsic viscosity is too high, there is a tendency that the viscosity is high, sufficient fluidity is not attained, and molding defects cannot be suppressed. Hence, when the intrinsic viscosity of the polyphenylene ether compound (a1) is in the above range, excellent heat resistance and moldability of the cured product can be realized.

The intrinsic viscosity here can be found from the product standard value of the polyphenylene ether compound (a1) used. The intrinsic viscosity here is an intrinsic viscosity measured in methylene chloride at 25° C. and more specifically is, for example, a value acquired by measuring the intrinsic viscosity of a methylene chloride solution (liquid temperature: 25° C.) at 0.18 g/45 ml using a viscometer. Examples of the viscometer include AVS500 Visco System manufactured by SCHOTT Instruments GmbH.

The polyphenylene ether compound (a1) is not particularly limited, and examples thereof include those containing polyphenylene ether composed of 2,6-dimethylphenol and at least one of a bifunctional phenol and a trifunctional phenol, and polyphenylene ether such as poly(2,6-dimethyl-1,4-phenylene oxide) as a main component. More specific examples of the polyphenylene ether compound (a1) include a polyphenylene ether compound represented by the following Formula (2) and a polyphenylene ether compound represented by the following Formula (3).

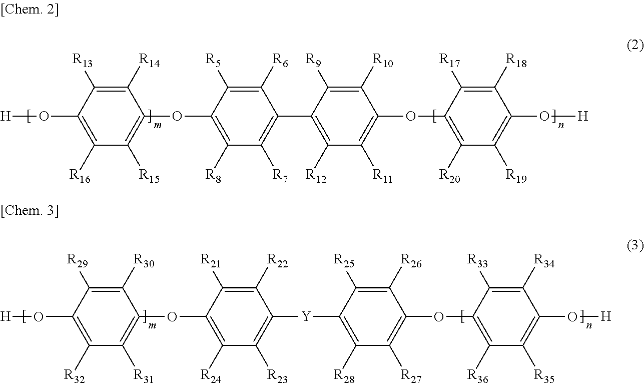

In Formulas (2) and (3), R₅ to R₂₀ and R₂₁ to R₃₆ are independent of each other. In other words, R₅ to R₂₀ and R₂₁ to R₃₆ may be the same group as or different groups from each other. Examples of R₅ to R₂₀ and R₂₁ to R₃₆ include those the same as R₁ to R₄ in Formula (1). In other words, R₅ to R₂₀ and R₂₁ to R₃₆ represent a hydrogen atom, an alkyl group, an alkenyl group, an alkynyl group, a formyl group, an alkylcarbonyl group, an alkenylcarbonyl group, or an alkynylcarbonyl group. In Formula (3), Y represents a linear, branched, or cyclic hydrocarbon having 20 or less carbon atoms. m and n each preferably represent 0 to 20. In addition, it is preferable that m and n represent numerical values so that the sum of m and n is 1 to 30. Hence, it is more preferable that m represents 0 to 20, n represents 0 to 20, and the sum of m and n represents 1 to 30.

In Formula (3), Y represents a linear, branched, or cyclic hydrocarbon having 20 or less carbon atoms as described above. Examples of Y include a group represented by the following Formula (4).

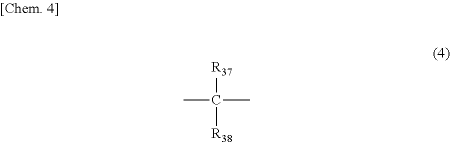

In Formula (4), R₃₇ and R₃₈ each independently represent a hydrogen atom or an alkyl group. Examples of the alkyl group include a methyl group. Examples of the group represented by Formula (4) include a methylene group, a methylmethylene group, and a dimethylmethylene group. Among these, a dimethylmethylene group is preferable.

More specific examples of the polyphenylene ether compound represented by Formula (2) include a polyphenylene ether compound represented by the following Formula (5). More specific examples of the polyphenylene ether compound represented by Formula (3) include a polyphenylene ether compound represented by the following Formula (6).

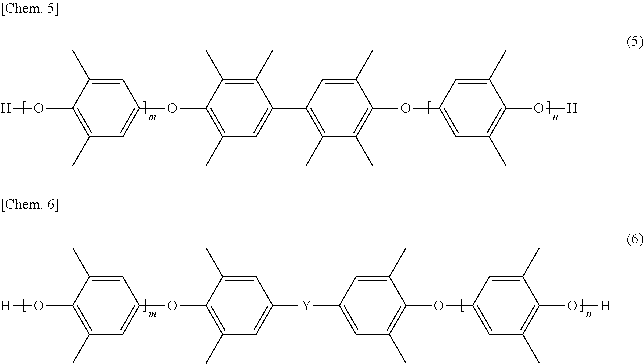

In Formulas (5) and (6), m and n are the same as m and n in Formulas (2) and (3), and specifically, m and n each preferably represent 0 to 20. In Formula (6), Y is the same as Y in Formula (3).

(Acid Anhydride (a2))

The acid anhydride (a2) is not particularly limited as long as it is an acid anhydride having an acid anhydride group in the molecule. The acid anhydride group may have a structure obtained by dehydration condensation of carboxylic acids in different molecules, or may have a structure obtained by dehydration condensation of two carboxylic acids in the molecule. The acid anhydride (a2) may be an acid anhydride (monofunctional acid anhydride) having one acid anhydride group in the molecule, or may be an acid anhydride (polyfunctional acid anhydride) having two or more acid anhydride groups in the molecule. The acid anhydride (a2) preferably includes an acid anhydride having one or more cyclic acid anhydride groups in the molecule. The number of carbon atoms in the acid anhydride (a2) is not particularly limited, but is preferably 6 or more, more preferably 8 or more and preferably 25 or less, more preferably 18 or less.

The acid anhydride (a2) is not particularly limited, but includes the monofunctional acid anhydride and the polyfunctional acid anhydride as described above.

The monofunctional acid anhydride is not particularly limited, but examples thereof include maleic anhydride, phthalic anhydride, succinic anhydride, trimellitic anhydride, a compound represented by the following Formula (7), methylbicyclo[2.2.1]heptane-2,3-dicarboxylic anhydride, bicyclo[2.2.1]heptane-2,3-dicarboxylic anhydride, nadic anhydride, methylnadic anhydride, hexahydrophthalic anhydride, methylhexahydrophthalic anhydride, 1,2,3,6-tetrahydrophthalic anhydride, tetrapropenyl succinic anhydride (3-dodecenyl succinic anhydride), and octenyl succinic anhydride.

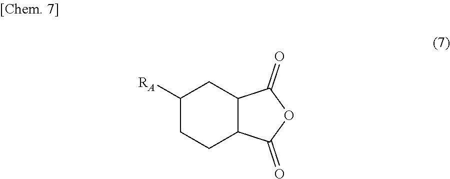

In Formula (7), RA represents a hydrogen atom or an alkyl group. The alkyl group is preferably an alkyl group having 1 to 12 carbon atoms, more preferably a methyl group. RA is also preferably a hydrogen atom. In other words, RA is preferably a hydrogen atom or a methyl group. The compound represented by Formula (7), where RA is a methyl group is 4-methylhexahydrophthalic anhydride. The compound represented by Formula (7), where RA is a hydrogen atom is hexahydrophthalic anhydride.

The polyfunctional acid anhydride is not particularly limited, but examples thereof include 1,2,3,4-butanetetracarboxylic dianhydride, ethylene glycol bisanhydrotrimellitate, glycerin bisanhydrotrimellitate monoacetate, 1,3,3a,4,5,9b-hexahydro-5 (tetrahydro-2,5-dioxo-3-furanyl) naphtho[1,2-C]furan-1,3-dione, pyromellitic anhydride, and benzophenonetetracarboxylic anhydride.

A commercially available product can be used as the acid anhydride. As succinic anhydride, for example, RIKACID SA manufactured by New Japan Chemical Co., Ltd. can be used. As 4-methylhexahydrophthalic anhydride, for example, RIKACID MH manufactured by New Japan Chemical Co., Ltd. can be used. As the hexahydrophthalic anhydride, for example, RIKACID HH manufactured by New Japan Chemical Co., Ltd. can be used. As 1,2,3,6-tetrahydrophthalic anhydride, for example, RIKACID TH manufactured by New Japan Chemical Co., Ltd. can be used. As tetrapropenyl succinic anhydride (3-dodecenyl succinic anhydride), for example, RIKACID DDSA manufactured by New Japan Chemical Co., Ltd. can be used. As octenyl succinic anhydride, for example, RIKACID OSA manufactured by New Japan Chemical Co., Ltd. can be used. As a mixture of methylbicyclo[2.2.1]heptane-2,3-dicarboxylic anhydride and bicyclo[2.2.1]heptane-2,3-dicarboxylic anhydride, for example, RIKACID HNA-100 manufactured by New Japan Chemical Co., Ltd. can be used. As a mixture of 4-methylhexahydrophthalic anhydride and hexahydrophthalic anhydride (mass ratio 70:30), for example, RIKACID MH-700 manufactured by New Japan Chemical Co., Ltd. can be used. As 1,2,3,4-butanetetracarboxylic dianhydride, for example, RIKACID BT-100 manufactured by New Japan Chemical Co., Ltd. can be used. As ethylene glycol bisanhydro trimellitate, for example, RIKACID TMEG-100, RIKACID TMEG-500, RIKACID TMEG-600, and RIKACID TMEG-S manufactured by New Japan Chemical Co., Ltd. can be used. As glycerin bisanhydro trimellitate monoacetate, for example, RIKACID TMTA-C manufactured by New Japan Chemical Co., Ltd. can be used. As 1,3,3a,4,5,9b-hexahydro-5 (tetrahydro-2,5-dioxo-3-furanyl) naphtho[1,2-C]furan-1,3-dione, for example, RIKACID TDA-100 manufactured by New Japan Chemical Co., Ltd. can be used.

The acid anhydride (a2) may be used singly or in combination of two or more kinds thereof.

### (Catalyst)

A catalyst may be used in the reaction. The catalyst is not particularly limited as long as it is a catalyst that contributes to the progress of the reaction of the polyethylene ether compound (a1) with the acid anhydride (a2). The catalyst may be a catalyst that contributes to the progress of not only the reaction of the polyethylene ether compound (a1) with the acid anhydride (a2) but also the reaction of the polyethylene ether compound (a1) with the other raw material (a3) and the reaction of the acid anhydride (a2) with the other raw materials (a3). Examples of the catalyst include 2-ethyl-4-methylimidazole (2E4MZ).

### (Reaction Product)

The resin composition contains at least either of the reaction product (A1) obtained by reacting the polyphenylene ether compound (a1) with the acid anhydride (a2) or the reaction product (A2) obtained by reacting the polyphenylene ether compound (a1) with the acid anhydride (a2) and the other raw material (a3) as the preliminary reaction product (A). In these reactions, the hydroxyl group in the polyphenylene ether compound (a1) may act on the acid anhydride group in the acid anhydride (a2) to open the ring of the acid anhydride group and form an ester bond. In other words, the reaction product has an ester bond in the molecule. In this reaction, a carboxyl group is generated by ring opening of the acid anhydride group. From these facts, when the reaction proceeds suitably, an ester/carboxyl-modified polyphenylene ether compound having an ester bond and a carboxyl group in the molecule is obtained. Hence, the preliminary reaction product (A) preferably includes an ester/carboxyl-modified polyphenylene ether compound having a terminal modified with a substituent having one or more ester bonds and one or more carboxyl groups. In other words, examples of the resin composition include a resin composition containing the ester/carboxyl-modified polyphenylene ether compound, the benzoxazine compound (B), and the reactive compound (C).

The reaction product is not particularly limited as long as it is at least either of the reaction product (A1) obtained by reacting the polyphenylene ether compound (a1) with the acid anhydride (a2) or the reaction product (A2) obtained by reacting the polyphenylene ether compound (a1) with the acid anhydride (a2) and the other raw material (a3), but examples thereof include a compound obtained by reacting the polyphenylene ether compound (a1) with a compound represented by Formula (7) as the acid anhydride (a2) and a compound obtained by reacting the polyphenylene ether compound (a1) with octenyl succinic anhydride as the acid anhydride (a2). Examples of the compound obtained by reacting the polyphenylene ether compound (a1) with a compound represented by Formula (7) as the acid anhydride (a2) include a compound represented by the following Formula (8) although the compound varies depending on the structure of the polyphenylene ether compound (a1), and the like.

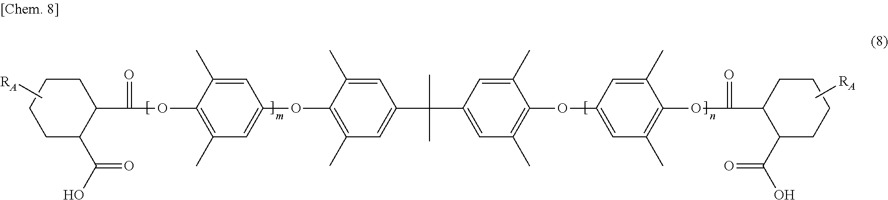

In Formula (8), RA includes those the same as R in Formula (7), and specifically represents a hydrogen atom or an alkyl group. m and n are the same as m and n in Formulas (2) and (3), and specifically, m and n each preferably represent 0 to 20.

The equivalent ratio (acid anhydride group in acid anhydride (a2)/hydroxyl group in polyphenylene ether compound (a1)) of the acid anhydride group in the acid anhydride (a2) to the hydroxyl group in the polyphenylene ether compound (a1) is preferably 1.5 or less, more preferably 0.3 to 1.5, still more preferably 0.8 to 1. In other words, the amount of acid anhydride groups in the acid anhydride (a2) is preferably 1.5 equivalents or less, more preferably 0.3 to 1.5 equivalents, still more preferably 0.8 to 1 equivalent when the amount of hydroxyl groups in the polyphenylene ether compound (a1) is set to 1 equivalent. A too large amount of polyphenylene ether compound (a1) remains when the amount of polyphenylene ether compound (a1) is too large, and a too large amount of acid anhydride (a2) remains when the amount of acid anhydride (a2) is too large, and it tends to be difficult to obtain a suitable preliminary reaction product. Hence, by blending the polyphenylene ether compound (a1) and the acid anhydride (a2) in the above range of equivalent ratio, a suitable preliminary reaction product can be obtained and a resin composition having excellent performance and a cured product thereof can be obtained. The equivalent is a relative value based on the reactive functional group, and the equivalent of hydroxyl groups in the polyphenylene ether compound can also be defined as the phenol equivalent.

Conditions for the reaction are not particularly limited as long as the reaction proceeds. As the conditions for the reaction, for example, conditions under which the ring opening rate of acid anhydride (a2) is 80% to 100% are preferable. In the preliminary reaction, the ring of acid anhydride (a2) is opened by the reaction with the polyphenylene ether compound (a1) as described above. For this reason, the degree of progress of the reaction can be confirmed by the ring opening rate of acid anhydride (a2). In the preliminary reaction product, the ring opening rate of acid anhydride (a2) is preferably 80% to 100% as described above. This decreases the amount of acid anhydride (a2) remaining in the preliminary reaction product (A) and can diminish adverse effects of the acid anhydride (a2). When the ring opening rate of acid anhydride (a2) is too low, a large amount of unreacted acid anhydride (a2) remains, and the acid anhydride (a2) is likely to volatilize and disappear during the fabrication of prepreg. As a result, the curing component is insufficient, and the degree of crosslinking of a cured product of the resin composition is considered to decrease, and the glass transition temperature of the cured product tends to decrease.

The ring opening rate of acid anhydride (a2) can be calculated, for example, by comparing the infrared absorption spectra of the mixtures before and after the reaction. The mixture may have a peak attributed to a cyclic acid anhydride group at near 1800 to 1900 cm⁻¹ before and after the reaction (preliminary reaction). The mixture may have a peak attributed to a benzene ring not involved in the reaction at near 1450 to 1580 cm⁻¹. Then, using the peak attributed to the benzene ring as an internal standard, the amounts (relative values) of the peaks attributed to the acid anhydride group before and after the reaction are determined. The amount of a peak is determined by the area ratio using the internal standard. Specifically, the area (A1) of a peak attributed to the acid anhydride group before the reaction, the area (A2) of a peak attributed to the acid anhydride group after the reaction, the area (B1) of a peak attributed to the benzene ring before the reaction, and the area (B2) of a peak attributed to the benzene ring after the reaction are used. Thereupon, the area ratio (A1/B1) is the amount of acid anhydride group before the reaction, and the area ratio (A2/B2) is the amount of acid anhydride group after the reaction. These are substituted into the following equation.

$$Ring opening rate ( \% ) = \{ 1 - ( {A}_{2} / {B}_{2} ) / ( {A}_{1} / {B}_{1} ) \} \times 100$$

The ring opening rate of acid anhydride can be thus determined.

Since the ring opening rate of the acid anhydride (a2) changes depending on the heating temperature and heating time during the preparation of varnish, it is preferable to adjust the heating conditions appropriately so that the ring opening rate is as high as possible, and it is more preferable to adjust the heating conditions appropriately so that the ring opening rate is 80% or more. The conditions for this preliminary reaction can be appropriately set by sampling the reaction product over time while performing the preliminary reaction and confirming the ring opening rate.

The conditions for the reaction include the conditions described above, and more specifically, the reaction temperature is preferably 30° C. to 100° C., more preferably 60° C. to 80° C. When the reaction temperature is too low, the reaction tends to hardly proceed. When the reaction temperature is too high, the acid anhydride (a2) may volatilize before the acid anhydride (a2) reacts with the polyphenylene ether compound (a1). Hence, when the reaction temperature is in the above range, the polyphenylene ether compound (a1) can be suitably reacted with the acid anhydride (a2). The reaction time is preferably 2 to 10 hours, more preferably 3 to 6 hours. When the reaction time is in the above range, the polyphenylene ether compound (a1) can be suitably reacted with the acid anhydride (a2).

### (Benzoxazine Compound (B))

The benzoxazine compound (B) is not particularly limited as long as it is a benzoxazine compound having an alkenyl group in the molecule. The benzoxazine compound (B) is a compound having a benzoxazine group in the molecule, and examples thereof include a benzoxazine resin. In other words, the benzoxazine compound (B) is a compound having an alkenyl group and a benzoxazine group in the molecule, and examples thereof include a compound having a benzoxazine group having an alkenyl group in the molecule. The benzoxazine compound (B) is a compound that is different from the reactive compound (C). The alkenyl group is not particularly limited, and examples thereof include alkenyl groups having 2 to 6 carbon atoms, specific examples of the alkenyl group include a vinyl group, an allyl group, and a butenyl group, and among these, an allyl group is preferable. Examples of the benzoxazine compound (B) include compounds having a benzoxazine group having an alkenyl group in the molecule. Examples of the benzoxazine group (benzoxazine group having an alkenyl group) include a benzoxazine group represented by the following Formula (9) and a benzoxazine group represented by the following Formula (10). Examples of the benzoxazine compound (B) include a benzoxazine compound having a benzoxazine group represented by the following Formula (9) in the molecule, a benzoxazine compound having a benzoxazine group represented by the following Formula (10) in the molecule, and a benzoxazine compound having a benzoxazine group represented by the following Formula (9) and a benzoxazine group represented by the following Formula (10) in the molecule. Examples of the benzoxazine compound having a benzoxazine group represented by the following Formula (9) in the molecule include a benzoxazine compound represented by the following Formula (11).

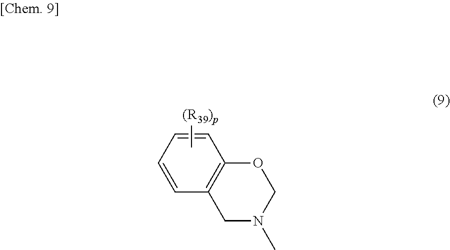

In Formula (9), R₃₉ represents an alkenyl group, and p represents 1 to 4. p is the average value of the degree of substitution of R₃₉, and is 1 to 4, preferably 1.

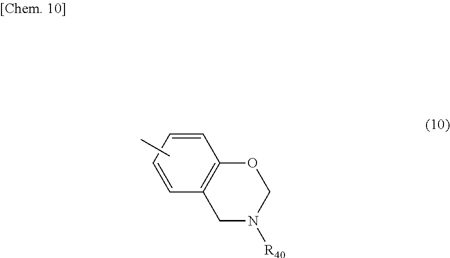

In Formula (10), R₄₀ represents an alkenyl group.

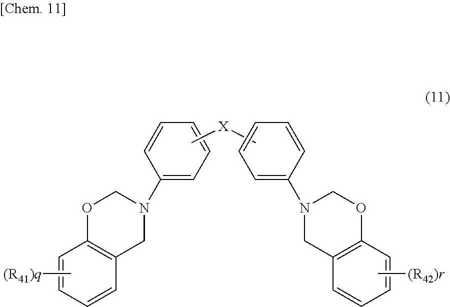

In Formula (11), R₄₁ and R₄₂ each independently represent an alkenyl group; X represents an alkylene group; q and r each independently represent 1 to 4. In other words, q and r may be the same as or different from each other and each represent 1 to 4.

As described above, the alkenyl group in Formulas (9) to (11) is not particularly limited, but is preferably an allyl group.

The alkylene group is not particularly limited, and examples thereof include a methylene group, an ethylene group, a propylene group, a butylene group, a pentylene group, a hexylene group, a heptylene group, an octane group, an icosane group, and a hexatriacontane group. Among these, a methylene group is preferable.

q is the average value of the degree of substitution of R₄₁, and is 1 to 4, preferably 1. r is the average value of the degree of substitution of R₄₂, and is 1 to 4, preferably 1.

As the benzoxazine compound (B), a commercially available product can be used, and for example, ALPd manufactured by SHIKOKU CHEMICALS CORPORATION or the like may be used.

As the benzoxazine compound (B), the benzoxazine compounds exemplified above may be used singly or in combination of two or more kinds thereof.

### (Reactive Compound (C))

The reactive compound (C) is not particularly limited as long as it is a reactive compound having an unsaturated double bond in the molecule. The reactive compound (C) is a compound that reacts with at least either of the preliminary reaction product (A) or the benzoxazine compound (B). The reactive compound (C) is a compound that is different from the benzoxazine compound (B). In other words, the reactive compound (C) is a reactive compound having an unsaturated double bond in the molecule other than the benzoxazine compound (B). The resin composition is a resin composition that contains the preliminary reaction product (A), the benzoxazine compound (B), and the reactive compound (C) having an unsaturated double bond in the molecule other than the benzoxazine compound (B). Examples of the reactive compound (C) include an unsaturated double bond-modified polyphenylene ether compound having a terminal modified with a substituent having an unsaturated double bond, an allyl compound, an acrylate compound, a methacrylate compound, vinyl compounds such as a polybutadiene compound and a styrene compound, and a maleimide compound. The reactive compound (C) is preferably the unsaturated double bond-modified polyphenylene ether compound and the maleimide compound among these. In other words, the reactive compound (C) preferably includes at least one selected from the group consisting of the unsaturated double bond-modified polyphenylene ether compound and the maleimide compound.

The unsaturated double bond-modified polyphenylene ether compound is not particularly limited as long as it is a modified polyphenylene ether compound having a terminal modified with a substituent having an unsaturated double bond. Examples of the unsaturated double bond-modified polyphenylene ether compound include those obtained by modifying a terminal of the polyphenylene ether compound (a1) with a substituent having an unsaturated double bond, and more specific examples thereof include a polyphenylene ether compound (styrene-modified polyphenylene ether) having a vinylbenzyl group (ethenylbenzyl group) at the molecular terminal, a polyphenylene ether compound (acryl-modified polyphenylene ether) having an acryloyl group at the molecular terminal, and a polyphenylene ether compound (methacryl-modified polyphenylene ether) having a methacryloyl group at the molecular terminal.

The allyl compound is a compound having an allyl group in the molecule, and examples thereof include a triallyl isocyanurate compound such as triallyl isocyanurate (TAIC), a diallyl bisphenol compound, and diallyl phthalate (DAP).

The acrylate compound is a compound having an acryloyl group in the molecule, and examples thereof include a monofunctional acrylate compound having one acryloyl group in the molecule and a polyfunctional acrylate compound having two or more acryloyl groups in the molecule. Examples of the monofunctional acrylate compound include methyl acrylate, ethyl acrylate, propyl acrylate, and butyl acrylate. Examples of the polyfunctional acrylate compound include diacrylate compounds such as tricyclodecanedimethanol diacrylate.

The methacrylate compound is a compound having a methacryloyl group in the molecule, and examples thereof include a monofunctional methacrylate compound having one methacryloyl group in the molecule and a polyfunctional methacrylate compound having two or more methacryloyl groups in the molecule. Examples of the monofunctional methacrylate compound include methyl methacrylate, ethyl methacrylate, propyl methacrylate, and butyl methacrylate. Examples of the polyfunctional methacrylate compound include dimethacrylate compounds such as tricyclodecanedimethanol dimethacrylate (DCP).

The vinyl compound is a compound having a vinyl group in the molecule. Examples of the vinyl compound include a monofunctional vinyl compound (monovinyl compound) having one vinyl group in the molecule and a polyfunctional vinyl compound having two or more vinyl groups in the molecule. Examples of the monofunctional vinyl compound include a styrene compound. Examples of the polyfunctional vinyl compound include a polyfunctional aromatic vinyl compound and a vinyl hydrocarbon-based compound. Examples of the vinyl hydrocarbon-based compound include divinylbenzene and a polybutadiene compound.

The maleimide compound is not particularly limited as long as it is a compound having a maleimide group in the molecule. Examples of the maleimide compound include a monofunctional maleimide compound having one maleimide group in the molecule, a polyfunctional maleimide compound having two or more maleimide groups in the molecule, and a modified maleimide compound. Examples of the modified maleimide compound include a modified maleimide compound in which a part of the molecule is modified with an amine compound, a modified maleimide compound in which a part of the molecule is modified with a silicone compound, and a modified maleimide compound in which a part of the molecule is modified with an amine compound and a silicone compound.

Examples of the maleimide compound include a maleimide compound having a phenylmaleimide group in the molecule, maleimide compounds containing at least either of an alkyl group having 6 or more carbon atoms or an aralkyl group having 6 or more carbon atoms in the molecule (a maleimide compound having an alkyl group having 6 or more carbon atoms in the molecule, a maleimide compound having an aralkyl group having 6 or more carbon atoms in the molecule, and a maleimide compound having an alkyl group having 6 or more carbon atoms and an aralkyl group having 6 or more carbon atoms in the molecule), a maleimide compound having a biphenylaralkyl structure in the molecule (biphenylaralkyl-type maleimide compound), and 1,6′-bismaleimide-(2,2,4-trimethyl) hexane. It is preferable that these maleimide compounds are used from the viewpoint of obtaining a resin composition that becomes a cured product having a lower relative dielectric constant and a higher glass transition temperature.

Examples of the maleimide compound having a phenylmaleimide group in the molecule include 4,4′-diphenylmethanebismaleimide, polyphenylmethanemaleimide, m-phenylenebismaleimide, bisphenol A diphenyl ether bismaleimide, 3,3′-dimethyl-5,5′-diethyl-4,4′-diphenylmethanebismaleimide, 4-methyl-1,3-phenylenebismaleimide, and a maleimide compound having a phenylmaleimide group and an arylene structure substituted at the meta position in the molecule. The arylene structure bonded in the meta-orientation is an arylene group bonded in the meta-orientation, and examples thereof include m-arylene groups such as m-phenylene and m-naphthylene.

A commercially available product can be used as the maleimide compound. Specifically, as 4,4′-diphenylmethanebismaleimide, for example, BMI-1000 manufactured by Daiwa Kasei Industry Co., Ltd. can be used. As polyphenylmethane maleimide, for example, BMI-2300 manufactured by Daiwa Kasei Industry Co., Ltd. can be used. As m-phenylenebismaleimide, for example, BMI-3000 manufactured by Daiwa Kasei Industry Co., Ltd. can be used. As bisphenol A diphenyl ether bismaleimide, for example, BMI-4000 manufactured by Daiwa Kasei Industry Co., Ltd. can be used. As 3,3′-dimethyl-5,5′-diethyl-4,4′-diphenylmethanebismaleimide, for example, BMI-5100 manufactured by Daiwa Kasei Industry Co., Ltd. can be used. As 4-methyl-1,3-phenylenebismaleimide, for example, BMI-7000 manufactured by Daiwa Kasei Industry Co., Ltd. can be used. As 1,6′-bismaleimide-(2,2,4-trimethyl) hexane, for example, BMI-TMH manufactured by Daiwa Kasei Industry Co., Ltd. can be used. As the biphenylaralkyl-type maleimide compound, for example, MIR-3000-70T manufactured by Nippon Kayaku Co., Ltd. can be used.

The reactive compound (C) may be used singly or in combination of two or more kinds thereof.

It is preferable that the reactive compound (C) includes at least one (C1) [first maleimide compound (C1)]selected from the biphenyl aralkyl-type maleimide compound or the polyphenylmethanemaleimide from the viewpoint of obtaining a resin composition that becomes a cured product having a higher glass transition temperature. The reactive compound (C) more preferably includes the first maleimide compound (C1) and a reactive compound (C2) [other reactive compound (C2)]other than the first maleimide compound (C1) among the reactive compounds (C). As the other reactive compound (C2), it is preferable to contain a maleimide compound (C3) [second maleimide compound (C3)] other than the first maleimide compound (C1) and the unsaturated double bond-modified polyphenylene ether compound [hereinafter, referred to as the unsaturated double bond-modified polyphenylene ether compound (C4)]. In other words, as the reactive compound (C), it is still more preferable to contain the first maleimide compound (C1), the second maleimide compound (C3), and the unsaturated double bond-modified polyphenylene ether compound (C4). As the maleimide compound (C3), for example, 3,3′-dimethyl-5,5′-diethyl-4,4′-diphenylmethanebismaleimide is preferable. When the second maleimide compound (C3) is contained as the reactive compound (C) [that is, not only the first maleimide compound (C1) but also the second maleimide compound (C3) are contained as the reactive compound (C)], the uniformity of the components contained in the cured product of the obtained resin composition can be further enhanced and a more suitable cured product is obtained.

In a case where the first maleimide compound (C1) and the other reactive compound (C2) are contained as the reactive compound (C), the content of the first maleimide compound (C1) is preferably 5 to 80 parts by mass, more preferably 10 to 70 parts by mass with respect to 100 parts by mass of the reactive compound (C) [with respect to 100 parts by mass of the total mass of the first maleimide compound (C1) and the other reactive compound (C2)].

In a case where the first maleimide compound (C1) and the other reactive compound (C2) are contained as the reactive compound (C) and further the second maleimide compound (C3) and the unsaturated double bond-modified polyphenylene ether compound (C4) are contained as the other reactive compound (C2), the content of the first maleimide compound (C1) is preferably 10 to 80 parts by mass, more preferably 25 to 60 parts by mass with respect to 100 parts by mass of the total mass of the first maleimide compound (C1) and the second maleimide compound (C3). The content of the unsaturated double bond-modified polyphenylene ether compound (C4) is preferably 5 to 70 parts by mass, more preferably 10 to 65 parts by mass with respect to 100 parts by mass of the total mass of the first maleimide compound (C1), the second maleimide compound (C3), and the unsaturated double bond-modified polyphenylene ether compound (C4) [with respect to 100 parts by mass of the total mass of the first maleimide compound (C1) and the other reactive compound (C2)].

In a case where the amount of the first maleimide compound (C1) is too small, there is a tendency that the effect exhibited by concurrent use of the first maleimide compound (C1) and the second maleimide compound (C3) cannot be fully exerted. Specifically, in the cured product of the obtained resin composition, there is a tendency that the effect of enhancing the uniformity of the contained components cannot be fully exhibited. In a case where the amount of the first maleimide compound (C1) is too large, and a case where the amount of the second maleimide compound (C3) is too small, and a case where the amount of the second maleimide compound (C3) is too large as well, the same problem as in the case where the amount of the first maleimide compound (C1) is too small occurs. Specifically, in these cases as well, in the cured product of the obtained resin composition, there is a tendency that the effect of enhancing the uniformity of the contained components cannot be fully exhibited. When the amount of the unsaturated double bond-modified polyphenylene ether compound (C4) is too small, there is a tendency that it is difficult to maintain low dielectric properties. When the amount of the unsaturated double bond-modified polyphenylene ether compound (C4) is too large, the total amount of the first maleimide compound (C1) and the second maleimide compound (C3) is small, and there is a tendency that the effect exhibited by concurrent use of the first maleimide compound (C1) and the second maleimide compound (C3) cannot be fully exerted. From these facts, as the first maleimide compound (C1), the second maleimide compound (C3), and the unsaturated double bond-modified polyphenylene ether compound (C4) are contained in the respective ranges, there is obtained a resin composition affording a cured product, which is excellent in low dielectric properties, heat resistance, adhesive properties to a metal foil, and desmear properties and has a high glass transition temperature as a cured product exhibiting higher uniformity.

### (Content)

The content of the preliminary reaction product (A) is not particularly limited, but is preferably 1 to 40 parts by mass, more preferably 3 to 40 parts by mass, still more preferably 5 to 30 parts by mass with respect to 100 parts by mass of the sum of the preliminary reaction product (A), the benzoxazine compound (B), and the reactive compound (C). In other words, the total content of the benzoxazine compound (B) and the reactive compound (C) is not particularly limited, but is 60 to 99 parts by mass, preferably 60 to 97 parts by mass, and more preferably 70 to 95 parts by mass with respect to 100 parts by mass of the sum of the preliminary reaction product (A), the benzoxazine compound (B), and the reactive compound (C).

The content of the benzoxazine compound (B) is not particularly limited, but is preferably 1 to 40 parts by mass, more preferably 3 to 30 parts by mass, still more preferably 3 to 20 parts by mass with respect to 100 parts by mass of the sum of the preliminary reaction product (A), the benzoxazine compound (B), and the reactive compound (C).

The content of the reactive compound (C) is not particularly limited, but is preferably 20 to 98 parts by mass, more preferably 30 to 94 parts by mass, still more preferably 50 to 92 parts by mass with respect to 100 parts by mass of the sum of the preliminary reaction product (A), the benzoxazine compound (B), and the reactive compound (C). In a case where the reactive compound (C) contains a maleimide compound (a case where the reactive compound (C) is a maleimide compound), the content of the maleimide compound is preferably 30 to 70 parts by mass, more preferably 30 to 60 parts by mass, still more preferably 40 to 60 parts by mass with respect to 100 parts by mass of the sum of the preliminary reaction product (A), the benzoxazine compound (B), and the reactive compound (C).

When the amount of the preliminary reaction product (A) is too small, that is, the sum of the benzoxazine compound (B) and the reactive compound (C) is too large, there is a tendency that the relative dielectric constant increases so that it is difficult to maintain excellent low dielectric properties or it is difficult to perform desmear. When the amount of the preliminary reaction product (A) is too large, that is, the sum of the benzoxazine compound (B) and the reactive compound (C) is too small, there is a tendency that it is too easy to perform desmear. In other words, when the amount of the benzoxazine compound (B) is too small or the amount of the reactive compound (C) is too small, there is a tendency that it is too easy to perform desmear. When the amount of the benzoxazine compound (B) is too large, that is, the sum of the benzoxazine compound (B) and the reactive compound (C) is too large, there is a tendency that the relative dielectric constant increases so that it is difficult to maintain excellent low dielectric properties or it is difficult to perform desmear. Hence, when the content of each of the preliminary reaction product (A), the benzoxazine compound (B), and the reactive compound (C) is in the above range, it is possible to suitably adjust the ease of desmear and the like while maintaining excellent low dielectric properties.

### (Inorganic Filler)

The resin composition may contain an inorganic filler or may not contain an inorganic filler, and preferably contains an inorganic filler. The inorganic filler is not particularly limited as long as it is an inorganic filler that can be used as an inorganic filler contained in a resin composition. Examples of the inorganic filler include metal oxides such as silica, alumina, titanium oxide, magnesium oxide and mica, metal hydroxides such as magnesium hydroxide and aluminum hydroxide, talc, aluminum borate, barium sulfate, aluminum nitride, boron nitride, barium titanate, magnesium carbonate such as anhydrous magnesium carbonate, and calcium carbonate. Among them, silica, metal hydroxides such as magnesium hydroxide and aluminum hydroxide, aluminum oxide, boron nitride, and barium titanate are preferable, and silica is more preferable. The silica is not particularly limited, and examples thereof include crushed silica, spherical silica, and silica particles.

The inorganic filler may be an inorganic filler subjected to a surface treatment or an inorganic filler not subjected to a surface treatment. Examples of the surface treatment include treatment with a silane coupling agent.

Examples of the silane coupling agent include a silane coupling agent having at least one functional group selected from the group consisting of a vinyl group, a styryl group, a methacryloyl group, an acryloyl group, a phenylamino group, an isocyanurate group, a ureido group, a mercapto group, an isocyanate group, an epoxy group, and an acid anhydride group. In other words, examples of this silane coupling agent include compounds having at least one of a vinyl group, a styryl group, a methacryloyl group, an acryloyl group, a phenylamino group, an isocyanurate group, a ureido group, a mercapto group, an isocyanate group, an epoxy group, or an acid anhydride group as a reactive functional group, and further a hydrolyzable group such as a methoxy group or an ethoxy group.

Examples of the silane coupling agent include vinyltriethoxysilane and vinyltrimethoxysilane as those having a vinyl group. Examples of the silane coupling agent include p-styryltrimethoxysilane and p-styryltriethoxysilane as those having a styryl group. Examples of the silane coupling agent include 3-methacryloxypropyltrimethoxysilane, 3-methacryloxypropylmethyldimethoxysilane, 3-methacryloxypropyltriethoxysilane, 3-methacryloxypropylmethyldiethoxysilane, and 3-methacryloxypropylethyldiethoxysilane as those having a methacryloyl group. Examples of the silane coupling agent include 3-acryloxypropyltrimethoxysilane and 3-acryloxypropyltriethoxysilane as those having an acryloyl group. Examples of the silane coupling agent include N-phenyl-3-aminopropyltrimethoxysilane and N-phenyl-3-aminopropyltriethoxysilane as those having a phenylamino group.

The average particle size of the inorganic filler is not particularly limited, and is preferably 0.05 to 10 μm, more preferably 0.1 to 8 μm. Here, the average particle size refers to the volume average particle size. The volume average particle size can be measured by, for example, a laser diffraction method and the like.

The resin composition may contain an inorganic filler as described above. In a case where the resin composition contains the inorganic filler, the content of the inorganic filler is preferably 10 to 250 parts by mass, more preferably 40 to 200 parts by mass with respect to 100 parts by mass of the total mass of the preliminary reaction product (A), the benzoxazine compound (B), and the reactive compound (C).

### (Other Components)

The resin composition according to the present embodiment may contain components (other components) other than the preliminary reaction product (A), the benzoxazine compound (B), and the reactive compound (C), if necessary, as long as the effects of the present invention are not impaired. As the other components contained in the resin composition according to the present embodiment, for example, additives such as a reactive compound other than the reactive compound (C), a reaction initiator, a curing accelerator, a catalyst, a polymerization retarder, a polymerization inhibitor, a dispersant, a leveling agent, a silane coupling agent, an antifoaming agent, an antioxidant, a heat stabilizer, an antistatic agent, an ultraviolet absorber, a dye or a pigment, and a lubricant may be further contained in addition to an inorganic filler as described above.

The resin composition according to the present embodiment may contain a reactive compound (other reactive compound) other than the reactive compound (C). The other reactive compound is a compound that is different from the benzoxazine compound (B) and the reactive compound (C), that is, a reactive compound not having an unsaturated double bond in the molecule. The other reactive compound is not particularly limited, but examples thereof include a benzoxazine compound (D) other than the benzoxazine compound (B), an acenaphthylene compound, a cyanate ester compound, and an active ester compound. The other reactive compound may be used singly or in combination of two or more kinds thereof.

The benzoxazine compound (D) is a compound that is different from the benzoxazine compound (B) and the reactive compound (C). In other words, the benzoxazine compound (D) is a benzoxazine compound not having an unsaturated double bond such as an alkenyl group in the molecule, and is a compound having a benzoxazine ring in the molecule, and examples thereof include a benzoxazine resin. Examples of the benzoxazine compound include a benzoxazine compound (phenolphthalein-type benzoxazine compound) having a phenolphthalein structure in the molecule, a bisphenol F-type benzoxazine compound, and a diaminodiphenylmethane (DDM)-type benzoxazine compound. More specific examples of the benzoxazine compound include 3,3′-(methylene-1,4-diphenylene)bis(3,4-dihydro-2H-1,3-benzoxazine) (P-d type benzoxazine compound) and a 2,2-bis(3,4-dihydro-2H-3-phenyl-1,3-benzoxazine) methane (F-a type benzoxazine compound).

The acenaphthylene compound is a compound having an acenaphthylene structure in the molecule. Examples of the acenaphthylene compound include acenaphthylene, alkylacenaphthylenes, halogenated acenaphthylenes, and phenylacenaphthylenes. Examples of the alkyl acenaphthylenes include 1-methyl acenaphthylene, 3-methyl acenaphthylene, 4-methyl acenaphthylene, 5-methyl acenaphthylene, 1-ethyl acenaphthylene, 3-ethyl acenaphthylene, 4-ethyl acenaphthylene, and 5-ethyl acenaphthylene. Examples of the halogenated acenaphthylenes include 1-chloroacenaphthylene, 3-chloroacenaphthylene, 4-chloroacenaphthylene, 5-chloroacenaphthylene, 1-bromoacenaphthylene, 3-bromoacenaphthylene, 4-bromoacenaphthylene, and 5-bromoacenaphthylene. Examples of the phenylacenaphthylenes include 1-phenylacenaphthylene, 3-phenylacenaphthylene, 4-phenylacenaphthylene, and 5-phenylacenaphthylene. The acenaphthylene compound may be a monofunctional acenaphthylene compound having one acenaphthylene structure in the molecule as described above or may be a polyfunctional acenaphthylene compound having two or more acenaphthylene structures in the molecule.

The cyanate ester compound is a compound having a cyanato group in the molecule, and examples thereof include 2,2-bis(4-cyanatophenyl) propane, bis(3,5-dimethyl-4-cyanatophenyl) methane, and 2,2-bis(4-cyanatophenyl) ethane.

The active ester compound is a compound having an ester group exhibiting high reaction activity in the molecule, and examples thereof include a benzenecarboxylic acid active ester, a benzenedicarboxylic acid active ester, a benzenetricarboxylic acid active ester, a benzenetetracarboxylic acid active ester, a naphthalenecarboxylic acid active ester, a naphthalenedicarboxylic acid active ester, a naphthalenetricarboxylic acid active ester, a naphthalenetetracarboxylic acid active ester, a fluorenecarboxylic acid active ester, a fluorenedicarboxylic acid active ester, a fluorenetricarboxylic acid active ester, and a fluorenetetracarboxylic acid active ester.

As described above, the resin composition according to the present embodiment may contain a reaction initiator. The curing reaction can proceed even though the resin composition does not contain a reaction initiator. However, a reaction initiator may be added since there is a case where it is difficult to raise the temperature until curing proceeds depending on the process conditions. The reaction initiator is not particularly limited as long as it can promote the curing reaction of the resin composition, and examples thereof include a peroxide and an organic azo compound. Examples of the peroxide include dicumyl peroxide, α,α′-bis(t-butylperoxy-m-isopropyl)benzene, 2,5-dimethyl-2,5-di(t-butylperoxy)-3-hexyne, and benzoyl peroxide. Examples of the organic azo compound include azobisisobutyronitrile. A metal carboxylate can be concurrently used if necessary. By doing so, the curing reaction can be further promoted. Among these, α,α′-bis(t-butylperoxy-m-isopropyl)benzene is preferably used. α,α′-Bis(t-butylperoxy-m-isopropyl)benzene has a relatively high reaction initiation temperature and thus can suppress the promotion of the curing reaction at the time point at which curing is not required, for example, at the time of prepreg drying, and can suppress a decrease in storage stability of the resin composition. α,α ′-Bis(t-butylperoxy-m-isopropyl) benzene exhibits low volatility, thus does not volatilize at the time of prepreg drying and storage, and exhibits favorable stability. The reaction initiators may be used singly or in combination of two or more kinds thereof.

As described above, the resin composition according to the present embodiment may contain a curing accelerator. The curing accelerator is not particularly limited as long as it can promote the curing reaction of the resin composition. Specific examples of the curing accelerator include imidazoles and derivatives thereof, organophosphorus compounds, amines such as secondary amines and tertiary amines, quaternary ammonium salts, organoboron compounds, and metal soaps. Examples of the imidazoles include 2-ethyl-4-methylimidazole, 2-methylimidazole, 2-phenyl-4-methylimidazole, 2-phenylimidazole, and 1-benzyl-2-methylimidazole. Examples of the organophosphorus compounds include triphenylphosphine, diphenylphosphine, phenylphosphine, tributylphosphine, and trimethylphosphine. Examples of the amines include dimethylbenzylamine, triethylenediamine, triethanolamine, and 1,8-diaza-bicyclo(5,4,0) undecene-7 (DBU). Examples of the quaternary ammonium salts include tetrabutylammonium bromide. Examples of the organoboron compounds include tetraphenylboron salts such as 2-ethyl-4-methylimidazole-tetraphenylborate and tetra-substituted phosphonium/tetra-substituted borate such as tetraphenylphosphonium/ethyltriphenylborate. The metal soap refers to a fatty acid metal salt, and may be a linear fatty acid metal salt or a cyclic fatty acid metal salt. Specific examples of the metal soaps include linear aliphatic metal salts and cyclic aliphatic metal salts having 6 to 10 carbon atoms. More specific examples thereof include aliphatic metal salts formed from linear fatty acids such as stearic acid, lauric acid, ricinoleic acid, and octylic acid and cyclic fatty acids such as naphthenic acid and metals such as lithium, magnesium, calcium, barium, copper, and zinc. Examples thereof include zinc octylate. The curing accelerators may be used singly or in combination of two or more kinds thereof.

As described above, the resin composition according to the present embodiment may contain a silane coupling agent. The silane coupling agent may be contained in the resin composition or may be contained as a silane coupling agent covered on the inorganic filler contained in the resin composition for surface treatment in advance. Among them, it is preferable that the silane coupling agent is contained as a silane coupling agent covered on the inorganic filler for surface treatment in advance, and it is more preferable that the silane coupling agent is contained as a silane coupling agent covered on the inorganic filler for surface treatment in advance and further is also contained in the resin composition. In the case of a prepreg, the silane coupling agent may be contained in the prepreg as a silane coupling agent covered on the fibrous base material for surface treatment in advance. Examples of the silane coupling agent include those similar to the silane coupling agents used in the surface treatment of the inorganic filler described above.

As described above, the resin composition according to the present embodiment may contain a flame retardant. The flame retardancy of a cured product of the resin composition can be enhanced by containing a flame retardant. The flame retardant is not particularly limited. Specifically, in the field in which halogen-based flame retardants such as bromine-based flame retardants are used, for example, ethylenedipentabromobenzene, ethylenebistetrabromoimide, decabromodiphenyloxide, and tetradecabromodiphenoxybenzene that have a melting point of 300° C. or more, and a bromostyrene-based compound that reacts with the polymerizable compound are preferable. It is considered that the elimination of halogen at a high temperature and the decrease in heat resistance can be suppressed by the use of a halogen-based flame retardant. There is a case where a flame retardant containing phosphorus (phosphorus-based flame retardant) is used in fields required to be halogen-free. The phosphorus-based flame retardant is not particularly limited, and examples thereof include a phosphate ester-based flame retardant, a phosphazene-based flame retardant, a bis(diphenylphosphine oxide)-based flame retardant, and a phosphinate-based flame retardant. Specific examples of the phosphate ester-based flame retardant include a condensed phosphate ester such as dixylenyl phosphate. Specific examples of the phosphazene-based flame retardant include phenoxyphosphazene. Specific examples of the bis(diphenylphosphine oxide)-based flame retardant include xylylenebis(diphenylphosphine oxide). Specific examples of the phosphinate-based flame retardant include metal phosphinates such as an aluminum dialkyl phosphinate. As the flame retardant, the respective flame retardants exemplified may be used singly or in combination of two or more kinds thereof.

### (Use)

The resin composition is used when a prepreg is manufactured, as described later. The resin composition is used when a resin layer included in a metal foil with resin and a film with resin is formed and when an insulating layer included in a metal-clad laminate and a wiring board is formed. As described above, the resin composition affords a cured product exhibiting excellent low dielectric properties such as a low relative dielectric constant. For this reason, the resin composition is suitably used to form an insulating layer included in a wiring board compatible with high frequencies, such as wiring boards for antennas and antenna boards for millimeter-wave radar. In other words, the resin composition is suitable for manufacture of wiring boards compatible with high frequencies.

### (Production Method)

The method for producing the resin composition is not particularly limited, and examples thereof include a method in which a preliminary reaction to obtain the preliminary reaction product (A) is conducted and then the obtained preliminary reaction product (A), the benzoxazine compound (B), and the reactive compound (C) are mixed together so as to have predetermined contents. Examples thereof include the method to be described later in the case of obtaining a varnish-like composition containing an organic solvent.

By using the resin composition according to the present embodiment, a prepreg, a metal-clad laminate, a wiring board, a metal foil with resin, and a film with resin can be obtained as described below.

### [Prepreg]

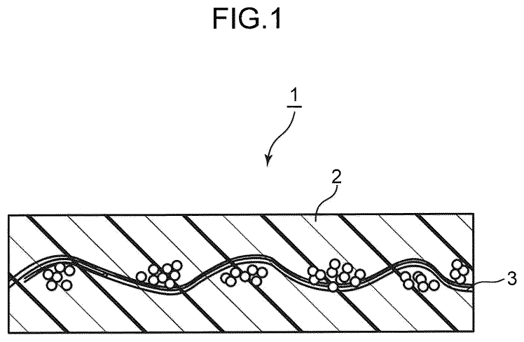

FIG. 1 is a schematic sectional view illustrating an example of a prepreg 1 according to an embodiment of the present invention.

As illustrated in FIG. 1, the prepreg 1 according to the present embodiment includes the resin composition or a semi-cured product 2 of the resin composition and a fibrous base material 3. This prepreg 1 includes the resin composition or the semi-cured product 2 of the resin composition and the fibrous base material 3 present in the resin composition or the semi-cured product 2 of the resin composition.

In the present embodiment, the semi-cured product is in a state in which the resin composition has been cured to an extent that the resin composition can be further cured. In other words, the semi-cured product is the resin composition in a semi-cured state (B-staged). For example, when a resin composition is heated, the viscosity of the resin composition first gradually decreases, then curing starts, and the viscosity gradually increases. In such a case, the semi-cured state includes a state where the viscosity has started to increase but curing is not completed, and the like.

The prepreg to be obtained using the resin composition according to the present embodiment may include a semi-cured product of the resin composition as described above or include the uncured resin composition itself. In other words, the prepreg may be a prepreg including a semi-cured product of the resin composition (the resin composition in B stage) and a fibrous base material or a prepreg including the resin composition before being cured (the resin composition in A stage) and a fibrous base material. The resin composition or a semi-cured product of the resin composition may be one obtained by drying or heating and drying the resin composition.

When a prepreg is manufactured, the resin composition 2 is often prepared in a varnish form and used in order to be impregnated into the fibrous base material 3 which is a base material for forming the prepreg. In other words, the resin composition 2 is usually a resin varnish prepared in a varnish form in many cases. Such a varnish-like resin composition (resin varnish) is prepared, for example, as follows.

First, the respective components which can be dissolved in an organic solvent are introduced into and dissolved in an organic solvent. At this time, heating may be performed if necessary. Thereafter, components which are used if necessary but are not dissolved in the organic solvent are added to and dispersed in the solution until a predetermined dispersion state is achieved using a ball mill, a bead mill, a planetary mixer, a roll mill or the like, whereby a varnish-like resin composition is prepared. The organic solvent used here is not particularly limited as long as it dissolves the preliminary reaction product (A), the benzoxazine compound (B), the reactive compound (C) and the like and does not inhibit the curing reaction. Specific examples thereof include toluene and methyl ethyl ketone (MEK).

Specific examples of the fibrous base material include glass cloth, aramid cloth, polyester cloth, a glass nonwoven fabric, an aramid nonwoven fabric, a polyester nonwoven fabric, pulp paper, and linter paper. When glass cloth is used, a laminate exhibiting excellent mechanical strength is obtained, and glass cloth subjected to flattening is particularly preferable. Specific examples of the flattening include a method in which glass cloth is continuously pressed at an appropriate pressure using a press roll to flatly compress the yarn. The thickness of the generally used fibrous base material is, for example, 0.01 mm or more and 0.3 mm or less. The glass fiber constituting the glass cloth is not particularly limited, and examples thereof include Q glass, NE glass, E glass, S glass, T glass, L glass, and L2 glass. The surface of the fibrous base material may be subjected to a surface treatment with a silane coupling agent. The silane coupling agent is not particularly limited, and examples thereof include a silane coupling agent having at least one selected from the group consisting of a vinyl group, an acryloyl group, a methacryloyl group, a styryl group, an amino group, and an epoxy group in the molecule.

The method for manufacturing the prepreg is not particularly limited as long as the prepreg can be manufactured. Specifically, when the prepreg is manufactured, the resin composition according to the present embodiment described above is often prepared in a varnish form and used as a resin varnish as described above.

Specific examples of the method for manufacturing the prepreg 1 include a method in which the fibrous base material 3 is impregnated with the resin composition 2, for example, the resin composition 2 prepared in a varnish form, and then dried. The fibrous base material 3 is impregnated with the resin composition 2 by dipping, coating, and the like. If necessary, the impregnation can be repeated a plurality of times. Moreover, at this time, it is also possible to finally adjust the composition and impregnated amount to the desired composition and impregnated amount by repeating impregnation using a plurality of resin compositions having different compositions and concentrations.

The fibrous base material 3 impregnated with the resin composition (resin varnish) 2 is heated under desired heating conditions, for example, at 40° C. or more and 180° C. or less for 1 minute or more and 10 minutes or less. By heating, the prepreg 1 before being cured (A-stage) or in a semi-cured state (B-stage) is obtained. By the heating, the organic solvent can be decreased or removed by being volatilized from the resin varnish.

The resin composition according to the present embodiment is a resin composition affording a cured product, which is excellent in low dielectric properties, heat resistance, adhesive properties to a metal foil, and desmear properties and has a high glass transition temperature. For this reason, the prepreg including this resin composition or a semi-cured product of this resin composition is a prepreg affording a cured product, which is excellent in low dielectric properties, heat resistance, adhesive properties to a metal foil, and desmear properties and has a high glass transition temperature. Moreover, a wiring board including an insulating layer containing a cured product, which is excellent in low dielectric properties, heat resistance, adhesive properties to a metal foil, and desmear properties and has a high glass transition temperature, can be suitably manufactured using this prepreg.

### [Metal-Clad Laminate]

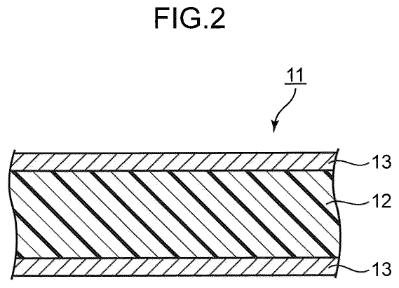

FIG. 2 is a schematic sectional view illustrating an example of a metal-clad laminate 11 according to an embodiment of the present invention.

As illustrated in FIG. 2, the metal-clad laminate 11 according to the present embodiment includes an insulating layer 12 containing a cured product of the resin composition and a metal foil 13 provided on the insulating layer 12. Examples of the metal-clad laminate 11 include a metal-clad laminate including an insulating layer 12 containing a cured product of the prepreg 1 illustrated in FIG. 1 and a metal foil 13 to be laminated together with the insulating layer 12. The insulating layer 12 may be formed of a cured product of the resin composition or a cured product of the prepreg. In addition, the thickness of the metal foil 13 varies depending on the performance and the like to be required for the finally obtained wiring board and is not particularly limited. The thickness of the metal foil 13 can be appropriately set depending on the desired purpose and is preferably, for example, 0.2 to 70 μm. Examples of the metal foil 13 include a copper foil and an aluminum foil, and the metal foil 13 may be a copper foil with carrier which includes a release layer and a carrier for the improvement in handleability in a case where the metal foil is thin.

The method for manufacturing the metal-clad laminate 11 is not particularly limited as long as the metal-clad laminate 11 can be manufactured. Specific examples thereof include a method in which the metal-clad laminate 11 is fabricated using the prepreg 1. Examples of this method include a method in which the double-sided metal foil-clad or single-sided metal foil-clad laminate 11 is fabricated by stacking one sheet or a plurality of sheets of prepreg 1, further stacking the metal foil 13 such as a copper foil on both or one of upper and lower surfaces of the prepregs 1, and laminating and integrating the metal foils 13 and prepregs 1 by heating and pressing. In other words, the metal-clad laminate 11 is obtained by laminating the metal foil 13 on the prepreg 1 and then performing heating and pressing. The heating and pressing conditions can be appropriately set depending on the thickness of the metal-clad laminate 11, the kind of the resin composition contained in the prepreg 1, and the like. For example, it is possible to set the temperature to 170° C. to 230° C., the pressure to 2 to 4 MPa, and the time to 60 to 150 minutes. Moreover, the metal-clad laminate may be manufactured without using a prepreg. Examples thereof include a method in which a varnish-like resin composition is applied on a metal foil to form a layer containing the resin composition on the metal foil and then heating and pressing is performed.

The resin composition according to the present embodiment is a resin composition affording a cured product, which is excellent in low dielectric properties, heat resistance, adhesive properties to a metal foil, and desmear properties and has a high glass transition temperature. For this reason, the metal-clad laminate including an insulating layer containing a cured product of this resin composition is a metal-clad laminate including an insulating layer containing a cured product, which is excellent in low dielectric properties, heat resistance, adhesive properties to a metal foil, and desmear properties and has a high glass transition temperature. Moreover, a wiring board including an insulating layer containing a cured product, which is excellent in low dielectric properties, heat resistance, adhesive properties to a metal foil, and desmear properties and has a high glass transition temperature, can be suitably manufactured using this metal-clad laminate.

### [Wiring Board]

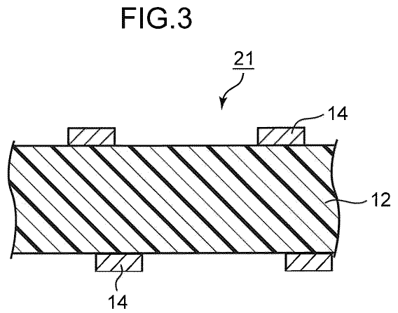

FIG. 3 is a schematic sectional view illustrating an example of a wiring board 21 according to an embodiment of the present invention.

As illustrated in FIG. 3, the wiring board 21 according to the present embodiment includes an insulating layer 12 containing a cured product of the resin composition and wiring 14 provided on the insulating layer 12. Examples of the wiring board 21 include a wiring board formed of an insulating layer 12 obtained by curing the prepreg 1 illustrated in FIG. 1 and wiring 14 which is laminated together with the insulating layer 12 and is formed by partially removing the metal foil 13. The insulating layer 12 may be formed of a cured product of the resin composition or a cured product of the prepreg.

The method for manufacturing the wiring board 21 is not particularly limited as long as the wiring board 21 can be manufactured. Specific examples thereof include a method in which the wiring board 21 is fabricated using the prepreg 1. Examples of this method include a method in which the wiring board 21, in which wiring is provided as a circuit on the surface of the insulating layer 12, is fabricated by forming wiring through etching and the like of the metal foil 13 on the surface of the metal-clad laminate 11 fabricated in the manner described above. In other words, the wiring board 21 is obtained by partially removing the metal foil 13 on the surface of the metal-clad laminate 11 and thus forming a circuit. Examples of the method for forming a circuit include circuit formation by a semi-additive process (SAP) or a modified semi-additive process (MSAP) in addition to the method described above.

The wiring board 21 is a wiring board including an insulating layer 12 containing a cured product, which is excellent in low dielectric properties, heat resistance, adhesive properties to a metal foil, and desmear properties and has a high glass transition temperature.

[Metal Foil with Resin]

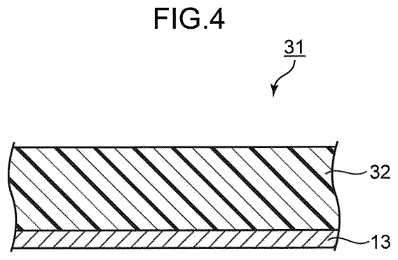

FIG. 4 is a schematic sectional view illustrating an example of a metal foil with resin 31 according to the present embodiment.

The metal foil with resin 31 according to the present embodiment includes a resin layer 32 containing the resin composition or a semi-cured product of the resin composition and a metal foil 13 as illustrated in FIG. 4. The metal foil with resin 31 includes the metal foil 13 on the surface of the resin layer 32. In other words, the metal foil with resin 31 includes the resin layer 32 and the metal foil 13 to be laminated together with the resin layer 32. The metal foil with resin 31 may include other layers between the resin layer 32 and the metal foil 13.

The resin layer 32 may contain a semi-cured product of the resin composition as described above or may contain the uncured resin composition. In other words, the metal foil with resin 31 may be a metal foil with resin including a resin layer containing a semi-cured product of the resin composition (the resin composition in B stage) and a metal foil or a metal foil with resin including a resin layer containing the resin composition before being cured (the resin composition in A stage) and a metal foil. The resin layer is only required to contain the resin composition or a semi-cured product of the resin composition and may or may not contain a fibrous base material. The resin composition or a semi-cured product of the resin composition may be one obtained by drying or heating and drying the resin composition. As the fibrous base material, those similar to the fibrous base materials of the prepreg can be used.

As the metal foil, metal foils used in metal-clad laminates or metal foils with resin can be used without limitation. Examples of the metal foil include a copper foil and an aluminum foil.

The metal foil with resin 31 may include a cover film and the like if necessary. By including a cover film, it is possible to prevent entry of foreign matter and the like. The cover film is not particularly limited, and examples thereof include a polyolefin film, a polyester film, a polymethylpentene film, and films formed by providing a release agent layer on these films.

The method for manufacturing the metal foil with resin 31 is not particularly limited as long as the metal foil with resin 31 can be manufactured. Examples of the method for manufacturing the metal foil with resin 31 include a method in which the varnish-like resin composition (resin varnish) is applied on the metal foil 13 and heated to manufacture the metal foil with resin 31. The varnish-like resin composition is applied on the metal foil 13 using, for example, a bar coater. The applied resin composition is heated under the conditions of, for example, 40° C. or more and 180° C. or less and 0.1 minute or more and 10 minutes or less. The heated resin composition is formed as the uncured resin layer 32 on the metal foil 13. By the heating, the organic solvent can be decreased or removed by being volatilized from the resin varnish.

The resin composition according to the present embodiment is a resin composition affording a cured product, which is excellent in low dielectric properties, heat resistance, adhesive properties to a metal foil, and desmear properties and has a high glass transition temperature. For this reason, the metal foil with resin including a resin layer containing this resin composition or a semi-cured product of this resin composition is a metal foil with resin including a resin layer that affords a cured product, which is excellent in low dielectric properties, heat resistance, adhesive properties to a metal foil, and desmear properties and has a high glass transition temperature. Moreover, this metal foil with resin can be used when a wiring board is manufactured which includes an insulating layer containing a cured product, which is excellent in low dielectric properties, heat resistance, adhesive properties to a metal foil, and desmear properties and has a high glass transition temperature. For example, by laminating the metal foil with resin on a wiring board, a multilayer wiring board can be manufactured. As a wiring board obtained using such a metal foil with resin, there is obtained a wiring board including an insulating layer containing a cured product, which is excellent in low dielectric properties, heat resistance, adhesive properties to a metal foil, and desmear properties and has a high glass transition temperature.

[Film with Resin]

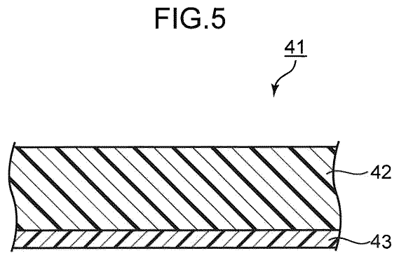

FIG. 5 is a schematic sectional view illustrating an example of a film with resin 41 according to the present embodiment.

The film with resin 41 according to the present embodiment includes a resin layer 42 containing the resin composition or a semi-cured product of the resin composition and a support film 43 as illustrated in FIG. 5. The film with resin 41 includes the resin layer 42 and the support film 43 to be laminated together with the resin layer 42. The film with resin 41 may include other layers between the resin layer 42 and the support film 43.

The resin layer 42 may contain a semi-cured product of the resin composition as described above or may contain the uncured resin composition. In other words, the film with resin 41 may be a film with resin including a resin layer containing a semi-cured product of the resin composition (the resin composition in B stage) and a support film or a film with resin including a resin layer containing the resin composition before being cured (the resin composition in A stage) and a support film. The resin layer is only required to contain the resin composition or a semi-cured product of the resin composition and may or may not contain a fibrous base material. The resin composition or a semi-cured product of the resin composition may be one obtained by drying or heating and drying the resin composition. As the fibrous base material, those similar to the fibrous base materials of the prepreg can be used.

As the support film 43, support films used in films with resin can be used without limitation. Examples of the support film include electrically insulating films such as a polyester film, a polyethylene terephthalate (PET) film, a polyimide film, a polyparabanic acid film, a polyether ether ketone film, a polyphenylene sulfide film, a polyamide film, a polycarbonate film, and a polyarylate film.

The film with resin 41 may include a cover film and the like if necessary. By including a cover film, it is possible to prevent entry of foreign matter and the like. The cover film is not particularly limited, and examples thereof include a polyolefin film, a polyester film, and a polymethylpentene film.

The support film and the cover film may be those subjected to surface treatments such as a matt treatment, a corona treatment, a release treatment, and a roughening treatment if necessary.

The method for manufacturing the film with resin 41 is not particularly limited as long as the film with resin 41 can be manufactured. Examples of the method for manufacturing the film with resin 41 include a method in which the varnish-like resin composition (resin varnish) is applied on the support film 43 and heated to manufacture the film with resin 41. The varnish-like resin composition is applied on the support film 43 using, for example, a bar coater. The applied resin composition is heated under the conditions of, for example, 40° C. or more and 180° C. or less and 0.1 minute or more and 10 minutes or less. The heated resin composition is formed as the uncured resin layer 42 on the support film 43. By the heating, the organic solvent can be decreased or removed by being volatilized from the resin varnish.

The resin composition according to the present embodiment is a resin composition affording a cured product, which is excellent in low dielectric properties, heat resistance, adhesive properties to a metal foil, and desmear properties and has a high glass transition temperature. For this reason, the film with resin including a resin layer containing this resin composition or a semi-cured product of this resin composition is a film with resin including a resin layer that affords a cured product, which is excellent in low dielectric properties, heat resistance, adhesive properties to a metal foil, and desmear properties and has a high glass transition temperature. Moreover, this film with resin can be used when a wiring board is suitably manufactured which includes an insulating layer containing a cured product, which is excellent in low dielectric properties, heat resistance, adhesive properties to a metal foil, and desmear properties and has a high glass transition temperature. A multilayer wiring board can be manufactured, for example, by laminating the film with resin on a wiring board and then peeling off the support film from the film with resin or by peeling off the support film from the film with resin and then laminating the film with resin on a wiring board. As a wiring board obtained using such a film with resin, there is obtained a wiring board including an insulating layer containing a cured product, which is excellent in low dielectric properties, heat resistance, adhesive properties to a metal foil, and desmear properties and has a high glass transition temperature.

This specification discloses techniques in various aspects as described above, and the main techniques among these are summarized below.

A resin composition according to a first aspect is a resin composition that contains a preliminary reaction product (A) obtained by previously reacting a mixture containing a polyphenylene ether compound (a1) having a hydroxyl group in the molecule and an acid anhydride (a2) having an acid anhydride group in a molecule, a benzoxazine compound (B) having an alkenyl group in a molecule, and a reactive compound (C) having an unsaturated double bond in a molecule.

A resin composition according to a second aspect is the resin composition according to the first aspect, in which an equivalent ratio of the acid anhydride group in the acid anhydride (a2) to the hydroxyl group in the polyphenylene ether compound (a1) is 1.5 or less.

A resin composition according to a third aspect is the resin composition according to the first or second aspect, in which a content of the preliminary reaction product (A) is 1 to 40 parts by mass with respect to 100 parts by mass of a sum of the preliminary reaction product (A), the benzoxazine compound (B), and the reactive compound (C).

A resin composition according to a fourth aspect is the resin composition according to any one of the first to third aspects, in which a content of the benzoxazine compound (B) is 1 to 40 parts by mass with respect to 100 parts by mass of a sum of the preliminary reaction product (A), the benzoxazine compound (B), and the reactive compound (C).

A resin composition according to a fifth aspect is the resin composition according to any one of the first to fourth aspects, in which a content of the reactive compound (C) is 20 to 98 parts by mass with respect to 100 parts by mass of a sum of the preliminary reaction product (A), the benzoxazine compound (B), and the reactive compound (C).

A resin composition according to a sixth aspect is the resin composition according to any one of the first to fifth aspects, in which the acid anhydride (a2) includes an acid anhydride having one or more cyclic acid anhydride groups in a molecule.

A resin composition according to a seventh aspect is the resin composition according to any one of the first to sixth aspects, in which the preliminary reaction product (A) includes a preliminary reaction product obtained by previously reacting the polyphenylene ether compound (a1) with the acid anhydride (a2).

A resin composition according to an eighth aspect is the resin composition according to any one of the first to seventh aspects, in which the preliminary reaction product (A) includes an ester/carboxyl-modified polyphenylene ether compound having a terminal modified with a substituent having one or more ester bonds and one or more carboxyl groups.

A resin composition according to a ninth aspect is the resin composition according to any one of the first to eighth aspects, in which the reactive compound (C) includes at least one selected from the group consisting of an unsaturated double bond-modified polyphenylene ether compound having a terminal modified with a substituent having an unsaturated double bond, an allyl compound, an acrylate compound, a methacrylate compound, a polybutadiene compound, a styrene compound, and a maleimide compound.

A resin composition according to a tenth aspect is the resin composition according to any one of the first to ninth aspects, in which the reactive compound (C) includes at least one selected from the group consisting of an unsaturated double bond-modified polyphenylene ether compound having a terminal modified with a substituent having an unsaturated double bond, and a maleimide compound.

A resin composition according to an eleventh aspect is the resin composition according to any one of the first to tenth aspects, in which the reactive compound (C) includes a maleimide compound, and a content of the maleimide compound is 30 to 70 parts by mass with respect to 100 parts by mass of a sum of the preliminary reaction product (A), the benzoxazine compound (B), and the reactive compound (C).

A resin composition according to a twelfth aspect is the resin composition according to any one of the first to eleventh aspects, further containing an inorganic filler.

A resin composition according to a thirteenth aspect is the resin composition according to the twelfth aspect, in which the inorganic filler is subjected to surface treatment with a silane coupling agent.

A prepreg according to a fourteenth aspect is a prepreg including the resin composition according to any one of the first to thirteenth aspects or a semi-cured product of the resin composition; and a fibrous base material.

A film with resin according to a fifteenth aspect is a film with resin including a resin layer containing the resin composition according to any one of the first to thirteenth aspects or a semi-cured product of the resin composition; and a support film.

A metal foil with resin according to a sixteenth aspect is a metal foil with resin including a resin layer containing the resin composition according to any one of the first to thirteenth aspects or a semi-cured product of the resin composition; and a metal foil.

A metal-clad laminate according to a seventeenth aspect is a metal-clad laminate including an insulating layer containing a cured product of the resin composition according to any one of the first to thirteenth aspects; and a metal foil.

A metal-clad laminate according to an eighteenth aspect is a metal-clad laminate including an insulating layer containing a cured product of the prepreg according to the fourteenth aspect; and a metal foil.

A wiring board according to a nineteenth aspect is a wiring board including an insulating layer containing a cured product of the resin composition according to any one of the first to thirteenth aspects; and a wiring.

A wiring board according to a twentieth aspect is a wiring board including an insulating layer containing a cured product of the prepreg according to the fourteenth aspect; and a wiring.

According to the present invention, it is possible to provide a resin composition affording a cured product, which is excellent in low dielectric properties, heat resistance, adhesive properties to a metal foil, and desmear properties and has a high glass transition temperature. Furthermore, according to the present invention, it is possible to provide a prepreg, a film with resin, a metal foil with resin, a metal-clad laminate, and a wiring board, which are obtained using the resin composition.

Hereinafter, the present invention will be described more specifically with reference to examples, but the scope of the present invention is not limited thereto.

### EXAMPLES

### [Preliminary Reaction Product (A): Preliminary Reaction Products A1 to A9]

First, a preliminary reaction product (A) used in each of Examples and Comparative Examples was prepared.

The respective components used in the production of preliminary reaction product (A) will be described.

(Polyphenylene Ether Compound (a1))

PPE: Polyphenylene ether compound having hydroxyl group in molecule (SA90 manufactured by SABIC Innovative Plastics Co., Ltd., number of terminal hydroxyl groups: 2, number average molecular weight Mn: 1700, phenol equivalent (hydroxyl group equivalent): 850 g/eq)

(Acid Anhydride (a2))

Acid anhydride 1: Mixture of 4-methylhexahydrophthalic anhydride and hexahydrophthalic anhydride (mass ratio 70:30) (RIKACID MH-700 manufactured by New Japan Chemical Co., Ltd., monofunctional acid anhydride, liquid alicyclic acid anhydride, functional group equivalent of acid anhydride group: 161 to 166 g/eq, freezing point: 20° C.) Acid anhydride 2: Octenyl succinic anhydride (RIKACID OSA manufactured by New Japan Chemical Co., Ltd., monofunctional acid anhydride, liquid alicyclic acid anhydride, functional group equivalent of acid anhydride group: 205 to 220 g/eq, freezing point: 15° C. or less)

### (Preparation Method)

First, the polyphenylene ether compound (a1) and the acid anhydride (a2) were blended at the composition (parts by mass) presented in Table 1, and this was diluted with toluene so that the solid concentration was 40% by mass. This was stirred and mixed using a disperser. By doing so, the polyphenylene ether compound (a1) and the acid anhydride (a2) were reacted to obtain a preliminary reaction product. As the reaction conditions of the polyphenylene ether compound (a1) and the acid anhydride (a2), the temperature (reaction temperature) and the stirring and mixing time (reaction time) during the stirring and mixing by a disperser were adjusted so that the ring opening rate determined by the calculation method was as high as possible. Specifically, the reaction temperature was set to 30° C. and the reaction time was set to 5 hours. Table 1 presents the ring opening rates in the preliminary reaction products A1 to A9.

The equivalent ratios presented in Table 1 are determined based on the reacting functional group (reactive group). In other words, the equivalent ratio presented in Table 1 is determined as the ratio of values acquired by dividing each blended amount by each functional group equivalent. The equivalent ratio is not calculated as an integer ratio or the like, but is a ratio determined by approximating the value appropriately by rounding off or the like. In other words, the equivalent ratio presented in Table 1 is a ratio determined by approximating the ratio of values acquired by dividing each blended amount by each functional group equivalent by rounding off.

Specifically, the preliminary reaction product A1 will be described. The phenol equivalent (hydroxyl group equivalent) in the polyphenylene ether compound (a1) is 850 g/eq, and the functional group equivalent of the acid anhydride group in the acid anhydride (a2) is 161 to 166 g/eq. Here, calculation is performed assuming that the functional group equivalent of the acid anhydride group in the acid anhydride (a2) is 163 g/eq. The amount of polyphenylene ether compound (a1) blended is 2.5 parts by mass, and the amount of the acid anhydride (a2) blended is 0.5 parts by mass. From these facts, the equivalent ratio (hydroxyl group equivalent in polyphenylene ether compound (a1): acid anhydride group equivalent in acid anhydride (a2)) is calculated to be (2.5/850):(0.5/163)=about 1:1. The equivalent ratio in the preliminary reaction product A1 is thus 1:1. In other words, the equivalent ratio of the acid anhydride groups in the acid anhydride (a2) to the hydroxyl groups in the polyphenylene ether compound (a1) is 1.

TABLE 1

| | | | A1 | A2 | A3 | A4 | A5 | A6 | A7 | A8 | A9 |
|---|---|---|---|---|---|---|---|---|---|---|---|
| Composition | Polyphenylene ether | PPE | 2.5 | 4.2 | 8.4 | 16.7 | 33.4 | 15.9 | 15.5 | 18.2 | 14.4 |
| (parts by | compound (a1) | | | | | | | | | | |
| mass) | Acid anhydride (a2) | Acid anhydride 1 | 0.5 | 0.8 | 1.6 | 3.3 | 6.6 | — | 4.5 | 1.8 | 5.6 |
| | | Acid anhydride 2 | — | — | — | — | — | 4.1 | — | — | — |

| | | | | | | | | | |
|---|---|---|---|---|---|---|---|---|---|
| Equivalent ratio (hydroxyl group in a1:acid | 1:1 | 1:1 | 1:1 | 1:1 | 1:1 | 1:1 | 1:1.5 | 1:0.5 | 1:2 |
| anhydride group in a2) | | | | | | | | | |
| Ring opening rate (%) | 90 | 91 | 90 | 88 | 87 | 89 | 92 | 93 | 49 |

### Examples 1 to 15 and Comparative Examples 1 to 6

The respective components used when a prepreg is fabricated in the present Examples will be described.

### (Preliminary Reaction Product (A))

As the preliminary reaction product (A), the preliminary reaction products A1 to A9 described above were used. The composition (parts by mass) of the preliminary reaction product (A) in Tables 2 and 3 indicates the mass of solid components.

### (PPE)

PPE: PPE the same as PPE used in the preparation of preliminary reaction product was used. Specifically, a polyphenylene ether compound having a hydroxyl group in the molecule (SA90 manufactured by SABIC Innovative Plastics Co., Ltd., number of terminal hydroxyl groups: 2, number average molecular weight Mn: 1700, phenol equivalent (hydroxyl group equivalent): 850 g/eq) was used. Meanwhile, in examples using this PPE (examples in which the composition of PPE is described in Table 2: Comparative Examples 1 and 2), the preliminary reaction is not conducted.

### (Acid Anhydride)

Acid anhydride 1: An acid anhydride the same as the acid anhydride 1 used in the preparation of preliminary reaction product was used. Specifically, a mixture of 4-methylhexahydrophthalic anhydride and hexahydrophthalic anhydride (mass ratio 70:30) (RIKACID MH-700 manufactured by New Japan Chemical Co., Ltd., monofunctional acid anhydride, liquid alicyclic acid anhydride, functional group equivalent of acid anhydride group: 161 to 166 g/eq, freezing point: 20° C.) was used. Meanwhile, in examples using this acid anhydride 1 (examples in which the composition of acid anhydride 1 is described in Table 2: Comparative Example 2), the preliminary reaction is not conducted.

Meanwhile, in Comparative Example 3 as well, the preliminary reaction is not conducted.

### (Benzoxazine Compound)

Alkenyl group-containing benzoxazine compound (B): Benzoxazine compound having allyl group that is alkenyl group in molecule (benzoxazine compound represented by Formula (11), where X is methylene group, R₄₁ and R₄₂ are allyl group, and q and r are 1, ALPd manufactured by SHIKOKU CHEMICALS CORPORATION, functional group equivalent of benzoxazine group: 244 g/eq)

Alkenyl group-free benzoxazine compound 1: Benzoxazine compound not having alkenyl group in molecule (3,3′-(methylene-1,4-diphenylene)bis(3,4-dihydro-2H-1,3-benzoxazine, P-d type benzoxazine compound manufactured by SHIKOKU CHEMICALS CORPORATION, functional group equivalent of benzoxazine group: 217 g/eq)

Alkenyl group-free benzoxazine compound 2: Benzoxazine compound not having alkenyl group in molecule (2,2-bis(3,4-dihydro-2H-3-phenyl-1,3-benzoxazine) methane, F-a type benzoxazine compound manufactured by SHIKOKU CHEMICALS CORPORATION, functional group equivalent of benzoxazine group: 210 g/eq)

### (Reactive Compound (C))

### (Reactive Compound: Maleimide Compound)

Maleimide compound 1: Biphenylaralkyl-type bismaleimide compound (MIR-3000-70MT manufactured by Nippon Kayaku Co., Ltd., bismaleimide compound, functional group equivalent of maleimide group: 275 g/eq)

Maleimide compound 2:3,3′-Dimethyl-5,5′-diethyl-4,4′-diphenylmethanebismaleimide (BMI-5100 manufactured by Nippon Kayaku Co., Ltd., bismaleimide compound, functional group equivalent of maleimide group: 221 g/eq)

(Reactive Compound: Reactive Compound Other than Maleimide Compound)

Modified PPE 1: Polyphenylene ether compound having vinylbenzyl group (ethenylbenzyl group) at molecular terminal (styrene-modified polyphenylene ether) (OPE-1200 manufactured by Mitsubishi Gas Chemical Company, Inc., number average molecular weight Mn: 1200, functional group equivalent of vinylbenzyl group: 670 g/eq)

Modified PPE 2: Polyphenylene ether compound with methacryloyl group at the molecular terminal (methacryl-modified polyphenylene ether) (SA9000 manufactured by Saudi Basic Industries Corporation, weight average molecular weight Mw: 1700, functional group equivalent of methacryloyl group: 850 g/eq)

### (Curing Accelerator)

2E4MZ: Imidazole-based curing accelerator (2-ethyl-4-methylimidazole, 2E4MZ manufactured by SHIKOKU CHEMICALS CORPORATION)

### (Inorganic Filler)

Inorganic filler 1: Spherical silica subjected to surface treatment with vinylsilane (SC2300-SVJ manufactured by ADMATECHS COMPANY LIMITED)

Inorganic filler 2: Spherical silica subjected to surface treatment with phenylaminosilane (SC2500-SXJ manufactured by ADMATECHS COMPANY LIMITED)

### (Preparation Method)

First, the components other than the inorganic filler were added to methyl ethyl ketone (MEK) at the compositions (parts by mass) presented in Tables 2 and 3 so that the solid concentration was 60% by mass, and the mixture was stirred and mixed using a disperser for homogenization. The inorganic filler was added to the homogenized mixture at the compositions (parts by mass) presented in Tables 2 and 3, and the mixture was stirred and mixed using a disperser for 2 hours for homogenization. By doing so, a varnish-like resin composition (varnish) was obtained.

Next, prepregs and evaluation substrates 1 to 3 (metal-clad laminates) were obtained as follows.

The obtained varnish was impregnated into a fibrous base material (glass cloth: “2116 type cloth” manufactured by Nitto Boseki Co., Ltd.) and then heated and dried at 150° C. using a non-contact type heating unit. By doing so, the solvent in the varnish was removed and the resin composition was semi-cured to obtain a prepreg (340 mm×510 mm). At that time, the content (resin content) of the components constituting the resin composition with respect to the prepreg was adjusted to be 47% by mass by the curing reaction.

Next, an evaluation substrate 1 (metal-clad laminate) was obtained as follows.

Six sheets of each of the obtained prepregs were stacked, and copper foil (manufactured by Mitsui Mining & Smelting Co., Ltd., thickness: 35 μm, ST foil, one roughened surface) was disposed on both sides of the stacked body so that the roughened surface was on the prepreg side. This as a body to be pressed was heated and pressed under the conditions of 200° C., 90 minutes, and a pressure of 2.94 MPa, thereby obtaining a copper-clad laminate (evaluation substrate 1: metal-clad laminate) having a copper foil bonded to both surfaces and a thickness of about 0.6 mm.

A copper-clad laminate (evaluation substrate 2: metal-clad laminate) having a copper foil bonded to both surfaces and a thickness of about 0.8 mm was obtained in the same manner as the evaluation substrate 1 except that the number of sheets of prepreg used was changed to 8.

A copper-clad laminate (evaluation substrate 3: metal-clad laminate) having a copper foil bonded to both surfaces and a thickness of about 0.1 mm was obtained in the same manner as the evaluation substrate 1 except that the number of sheets of prepreg used was changed to 1.

The evaluation substrates 1 to 3 (copper-clad laminates) fabricated as described above were evaluated by the following methods.

### [Desmear Properties]

First, the copper foil on the surface of the evaluation substrate 1 (copper-clad laminate) was removed by etching. As a desmear process, the substrate from which the copper foil was removed was immersed in a swelling liquid (Swelling Dip Securiganth P manufactured by Atotech) at 60° C. for 5 minutes, then immersed in an aqueous potassium permanganate solution (Concentrate Compact CP manufactured by Atotech) at 80° C. for 10 minutes, and then subjected to neutralization. Before and after such a desmear process, the weight of the substrate was measured, and the amount of weight decrease (weight of substrate before desmear process-weight of substrate after desmear process) due to the desmear process was calculated, and the amount of weight decrease per 1 mm² (mg/mm²) was calculated from the amount of weight decrease. Based on the amount of weight decrease per 1 mm², evaluation was performed as follows.

It was evaluated as “A (×)” when the amount of weight decrease per 1 mm² was less than 15 mg/mm², it was evaluated as “B (∘)” when the amount of weight decrease per 1 mm² was 15 mg/mm² or more and less than 30 mg/mm², it was evaluated as “C (⊚)” when the amount of weight decrease per 1 mm² was 30 mg/mm² or more and less than 45 mg/mm², and it was evaluated as “D (×)” when the amount of weight decrease per 1 mm² was 45 mg/mm² or more.

The “A (×)” is not preferable since it is difficult to remove desmear, and the “D (×)” is not preferable since the resin is excessively removed and the shape of the vias and the like cannot be maintained. On the other hand, “B (∘)” and “C (⊚)” are preferable since desmear can be removed while the shape of vias and the like can be maintained, and “C (⊚)” is more preferable from this point.

### [Relative Dielectric Constant Dk]

The relative dielectric constant (Dk) at 1 GHz was measured by the cavity perturbation method using an unclad substrate obtained by removing the copper foil from the evaluation substrate 2 (copper-clad laminate) by etching as a test piece. Specifically, the relative dielectric constant (Dk) of the unclad substrate (insulating layer included in the evaluation substrate 2) was measured at 1 GHz in conformity with IPC-TM-650 2.5.5.9 using “Impedance/Material Analyzer 4291A” manufactured by Hewlett-Packard Company. A relative dielectric constant of 3.4 or less is favorable.

### [Glass Transition Temperature Tg]

Using an unclad substrate obtained by removing the copper foil from the evaluation substrate 2 (copper-clad laminate) by etching as a test piece, the glass transition temperature (Tg) of the unclad substrate (the insulating layer included in the evaluation substrate 2) was measured using a viscoelastic spectrometer “DMS6100” manufactured by Seiko Instruments Inc. At this time, dynamic viscoelasticity measurement (DMA) was performed with a tensile module at a frequency of 10 Hz, and the temperature at which tan 8 was maximized when the temperature was raised from room temperature to 280° C. at a rate of temperature rise of 5° C./min was taken as the glass transition temperature Tg (° C.). A glass transition temperature of 240° C. or more is favorable.

### [Heat Resistance (Oven Heat Resistance)]

The evaluation substrate 3 was left in dryers of which the temperatures were set to 240° C., 260° C., and 280° C., respectively, for 1 hour. Thereafter, the presence or absence of blistering in the laminate after being left was visually observed. It was evaluated as “A (×)” when blistering was recognized in the laminate after being left in a dryer at 240° C. It was evaluated as “B (A)” when blistering was recognized in the laminate after being left in a dryer at 260° C. but blistering was not recognized in the laminate after being left in a dryer at 240° C. It was evaluated as “C (∘)” when blistering was recognized in the laminate after being left in a dryer at 280° C. but blistering was not recognized in the laminate after being left in a dryer at 260° C. It was evaluated as “D (⊚)” when blistering was not recognized in the laminate after being left in a dryer at 280° C. “B (A)”, “C (∘)”, and “D (⊚)” are determined to be favorable in terms of oven heat resistance, “C (∘)”, and “D (⊚)” are more preferable, and “D (⊚)” is still more preferable.

### [Peel Strength]

The copper foil was peeled off from the evaluation substrate 3 (metal-clad laminate), and the peel strength at that time was measured in conformity with JIS C 6481. Specifically, the copper foil was peeled off from the evaluation substrate at a speed of 50 mm/min using a tensile tester, and the peel strength (N/mm) at that time was measured.

The results of the respective evaluations are presented in Tables 2 and 3.

TABLE 2

| | | | Example | | | | | | | | |
|---|---|---|---|---|---|---|---|---|---|---|---|
| | | | 1 | 2 | 3 | 4 | 5 | 6 | 7 | 8 | 9 |
| Composition | Preliminary reaction product (A) | | A1 | A2 | A3 | A4 | A5 | A6 | A7 | A8 | A9 |
| (parts by | | | 3 | 5 | 10 | 20 | 40 | 20 | 20 | 20 | 20 |
| mass) | PPE | | — | — | — | — | — | — | — | — | — |
| | Acid anhydride 1 | | — | — | — | — | — | — | — | — | — |
| | Alkenyl group-containing | | 10 | 10 | 10 | 10 | 10 | 10 | 10 | 10 | 10 |
| | benzoxazine compound (B) | | | | | | | | | | |
| | Alkenyl group-free | | — | — | — | — | — | — | — | — | — |
| | benzoxazine compound 1 | | | | | | | | | | |
| | Alkenyl group-free | | — | — | — | — | — | — | — | — | — |
| | benzoxazine compound 2 | | | | | | | | | | |
| | Reactive | Maleimide compound 1 | 20 | 20 | 20 | 20 | 20 | 20 | 20 | 20 | 20 |
| | compound | Maleimide compound 2 | 20 | 20 | 20 | 20 | 20 | 20 | 20 | 20 | 20 |
| | (C) | Modified PPE 1 | 47 | 45 | 40 | 30 | 10 | 30 | 30 | 30 | 30 |
| | Curing | 2E4MZ | 0.3 | 0.3 | 0.3 | 0.3 | 0.3 | 0.3 | 0.3 | 0.3 | 0.3 |
| | accelerator | | | | | | | | | | |

| | | | | | | | | | | |
|---|---|---|---|---|---|---|---|---|---|---|
| | Inorganic filler 1 | 100 | 100 | 100 | 100 | 100 | 100 | 100 | 100 | 100 |
| Evaluation | Desmear properties | B(◯) | C(⊙) | C(⊙) | C(⊙) | C(⊙) | C(⊙) | C(⊙) | B(◯) | C(⊙) |
| | Relative dielectric constant Dk | 3.2 | 3.2 | 3.2 | 3.3 | 3.4 | 3.3 | 3.3 | 3.3 | 3.4 |
| | Glass transition temperature Tg (° C.) | 268 | 265 | 262 | 255 | 251 | 254 | 256 | 253 | 249 |
| | Heat resistance | D(⊙) | D(⊙) | D(⊙) | C(◯) | C(◯) | C(◯) | C(◯) | C(◯) | B(Δ) |
| | Peel strength (N/mm) | 0.69 | 0.68 | 0.65 | 0.62 | 0.58 | 0.61 | 0.60 | 0.62 | 0.59 |

| | | Comparative Example | | | | | |
|---|---|---|---|---|---|---|---|
| | | 1 | 2 | 3 | 4 | 5 | 6 |
| Composition | Preliminary reaction product (A) | — | — | — | A4 | A4 | A4 |
| (parts by | | | | | 20 | 20 | 20 |
| mass) | PPE | 30 | 16.7 | — | — | — | — |
| | Acid anhydride 1 | — | 3.3 | — | — | — | — |
| | Alkenyl group-containing | 10 | 10 | 10 | — | — | — |
| | benzoxazine compound (B) | | | | | | |
| | Alkenyl group-free | — | — | — | 10 | — | — |
| | benzoxazine compound 1 | | | | | | |
| | Alkenyl group-free | — | — | — | — | 10 | — |
| | benzoxazine compound 2 | | | | | | |

| | | | | | | | |
|---|---|---|---|---|---|---|---|
| Reactive | Maleimide compound 1 | 20 | 20 | 20 | 20 | 20 | 20 |
| compound | Maleimide compound 2 | 20 | 20 | 20 | 20 | 20 | 20 |
| (C) | Modified PPE 1 | 20 | 30 | 50 | 30 | 30 | 40 |
| Curing | 2E4MZ | 0.3 | 0.3 | 0.3 | 0.3 | 0.3 | 0.3 |
| accelerator | | | | | | | |

| | | | | | | | |
|---|---|---|---|---|---|---|---|
| | Inorganic filler 1 | 100 | 100 | 100 | 100 | 100 | 100 |
| Evaluation | Desmear properties | D(X) | A(X) | A(X) | C(⊙) | C(⊙) | B(◯) |
| | Relative dielectric constant Dk | 3.4 | 3.6 | 3.1 | 3.4 | 3.4 | 3.3 |
| | Glass transition temperature Tg (° C.) | 210 | 215 | 270 | 238 | 232 | 225 |
| | Heat resistance | D(⊙) | A(X) | D(⊙) | C(◯) | C(◯) | C(◯) |
| | Peel strength (N/mm) | 0.47 | 0.48 | 0.71 | 0.52 | 0.50 | 0.51 |

TABLE 3

| | | | Example | | | | | |
|---|---|---|---|---|---|---|---|---|
| | | | 10 | 11 | 12 | 13 | 14 | 15 |
| Composition | Preliminary reaction product (A) | | A4 | A4 | A4 | A4 | A4 | A4 |
| (parts by | | | 20 | 20 | 20 | 20 | 20 | 20 |
| mass) | Alkenyl group-containing | | 3 | 5 | 20 | 10 | 10 | 10 |
| | benzoxazine compound (B) | | | | | | | |
| | Reactive | Maleimide compound 1 | 27 | 25 | 10 | 30 | 20 | 20 |
| | compound | Maleimide compound 2 | 20 | 20 | 20 | 10 | 20 | 20 |
| | (C) | Modified PPE 1 | 30 | 30 | 30 | 30 | — | 30 |
| | | Modified PPE 2 | — | — | — | — | 30 | — |
| | Curing | 2E4MZ | 0.3 | 0.3 | 0.3 | 0.3 | 0.3 | 0.3 |
| | accelerator | | | | | | | |

| | | | | | | | |
|---|---|---|---|---|---|---|---|
| | Inorganic filler 1 | 100 | 100 | 100 | 100 | 100 | — |
| | Inorganic filler 2 | — | — | — | — | — | 100 |
| Evaluation | Desmear properties | B(◯) | C(⊙) | C(⊙) | C(⊙) | C(⊙) | C(⊙) |
| | Relative dielectric constant Dk | 3.3 | 3.3 | 3.4 | 3.3 | 3.3 | 3.3 |
| | Glass transition temperature Tg (° C.) | 249 | 252 | 263 | 261 | 252 | 255 |
| | Heat resistance | C(◯) | C(◯) | C(◯) | C(◯) | C(◯) | C(◯) |
| | Peel strength (N/mm) | 0.57 | 0.59 | 0.66 | 0.66 | 0.65 | 0.65 |

As can be seen from Tables 2 and 3, in the case (Examples 1 to 15) of resin compositions containing a preliminary reaction product (A) obtained by previously reacting a polyphenylene ether compound (a1) and an acid anhydride (a2), a benzoxazine compound (B), and a reactive compound (C), cured products are obtained which are excellent in low dielectric properties, heat resistance, adhesive properties to a metal foil, and desmear properties and have a high glass transition temperature.

In contrast, in cases (Comparative Examples 1 and 2) where the PPE that has not been subjected to the preliminary reaction is contained but the preliminary reaction product (A) is not contained, it can be seen that the glass transition temperature is low, the desmear properties are inferior, and further the peel strength is also inferior. In Comparative Example 1, it can be seen that the resin is too easily scraped off by desmear since a preliminary reaction product is not contained as well as an acid anhydride is not contained. In Comparative Example 2, a preliminary reaction product is not contained but PPE and an acid anhydride, which have not been subjected to the preliminary reaction, are contained, and as a result, the dielectric loss tangent is low and the heat resistance is also inferior. In a case (Comparative Example 3) where the preliminary reaction product (A) is not contained as well as PPE and an acid anhydride, which have not been subjected to the preliminary reaction, are not contained, it is difficult to perform desmear. From these facts as well, it can be seen that it is required to contain the preliminary reaction product (A).

In cases (Comparative Examples 4 to 6) where the benzoxane compound (B) is not contained, it can be seen that the glass transition temperature is low and the peel strength is also inferior. In cases (Comparative Examples 4 and 5) where the benzoxane compound (B) is not contained but a benzoxane compound other than the benzoxane compound (B) is contained as well, it can be seen that the glass transition temperature is low and the peel strength is also inferior.

In cases (Examples 1 to 8 and Examples 10 to 15) where preliminary reaction products (A1 to A8) obtained by conducting the preliminary reaction so that the equivalent ratio of the acid anhydride groups in the acid anhydride (a2) to the hydroxyl groups in the polyphenylene ether compound (a1) is 1.5 or less are contained as the preliminary reaction product (A), the heat resistance is higher than that in a case (Example 9) where a preliminary reaction product (A9) obtained by conducting the preliminary reaction so that the equivalent ratio exceeds 1.5 is contained. From this fact, it can be seen that a cured product, which is excellent in low dielectric properties, adhesive properties to a metal foil, and desmear properties, has a high glass transition temperature, and is superior in heat resistance, is obtained as a preliminary reaction product obtained by conducting the preliminary reaction so that the equivalent ratio is 1.5 or less is used as the preliminary reaction product (A).

This application is based on Japanese Patent Application No. 2022-115730 filed on Jul. 20, 2022, and the contents of which are included in the present application.

In order to express the present invention, the present invention has been described above appropriately and sufficiently through the embodiments. However, it should be recognized by those skilled in the art that changes and/or improvements of the above-described embodiments can be readily made. Accordingly, changes or improvements made by those skilled in the art shall be construed as being included in the scope of the claims unless otherwise the changes or improvements are at the level which departs from the scope of the appended claims.

### INDUSTRIAL APPLICABILITY

According to the present invention, there is provided a resin composition affording a cured product, which is excellent in low dielectric properties, heat resistance, adhesive properties to a metal foil, and desmear properties and has a high glass transition temperature. In addition, the present invention provides a prepreg, a film with resin, a metal foil with resin, a metal-clad laminate, and a wiring board which are obtained using the resin composition.

1. A resin composition comprising:
a preliminary reaction product (A) obtained by previously reacting a mixture containing a polyphenylene ether compound (a1) having a hydroxyl group in a molecule and an acid anhydride (a2) having an acid anhydride group in a molecule;
a benzoxazine compound (B) having an alkenyl group in a molecule; and
a reactive compound (C) having an unsaturated double bond in a molecule.

2. The resin composition according to claim 1, wherein an equivalent ratio of the acid anhydride group in the acid anhydride (a2) to the hydroxyl group in the polyphenylene ether compound (a1) is 1.5 or less.

3. The resin composition according to claim 1, wherein a content of the preliminary reaction product (A) is 1 to 40 parts by mass with respect to 100 parts by mass of a sum of the preliminary reaction product (A), the benzoxazine compound (B), and the reactive compound (C).

4. The resin composition according to claim 1, wherein a content of the benzoxazine compound (B) is 1 to 40 parts by mass with respect to 100 parts by mass of a sum of the preliminary reaction product (A), the benzoxazine compound (B), and the reactive compound (C).

5. The resin composition according to claim 1, wherein a content of the reactive compound (C) is 20 to 98 parts by mass with respect to 100 parts by mass of a sum of the preliminary reaction product (A), the benzoxazine compound (B), and the reactive compound (C).

6. The resin composition according to claim 1, wherein the acid anhydride (a2) includes an acid anhydride having one or more cyclic acid anhydride groups in a molecule.

7. The resin composition according to claim 1, wherein the preliminary reaction product (A) includes a preliminary reaction product obtained by previously reacting the polyphenylene ether compound (a1) with the acid anhydride (a2).

8. The resin composition according to claim 1, wherein the preliminary reaction product (A) includes an ester/carboxyl-modified polyphenylene ether compound having a terminal modified with a substituent having one or more ester bonds and one or more carboxyl groups.

9. The resin composition according to claim 1, wherein the reactive compound (C) includes at least one selected from the group consisting of an unsaturated double bond-modified polyphenylene ether compound having a terminal modified with a substituent having an unsaturated double bond, an allyl compound, an acrylate compound, a methacrylate compound, a polybutadiene compound, a styrene compound, and a maleimide compound.

10. The resin composition according to claim 1, wherein the reactive compound (C) includes at least one selected from the group consisting of an unsaturated double bond-modified polyphenylene ether compound having a terminal modified with a substituent having an unsaturated double bond, and a maleimide compound.

11. The resin composition according to claim 1, wherein
the reactive compound (C) includes a maleimide compound, and
a content of the maleimide compound is 30 to 70 parts by mass with respect to 100 parts by mass of a sum of the preliminary reaction product (A), the benzoxazine compound (B), and the reactive compound (C).

12. The resin composition according to claim 1, further comprising an inorganic filler.

13. The resin composition according to claim 12, wherein the inorganic filler is subjected to surface treatment with a silane coupling agent.

14. A prepreg comprising:
the resin composition according to claim 1 or a semi-cured product of the resin composition; and
a fibrous base material.

15. A film with resin comprising:
a resin layer containing the resin composition according to claim 1 or a semi-cured product of the resin composition; and
a support film.

16. A metal foil with resin comprising:
a resin layer containing the resin composition according to claim 1 or a semi-cured product of the resin composition; and
a metal foil.

17. A metal-clad laminate comprising:
an insulating layer containing a cured product of the resin composition according to claim 1; and
a metal foil.

18. A metal-clad laminate comprising:
an insulating layer containing a cured product of the prepreg according to claim 14; and
a metal foil.

19. A wiring board comprising:
an insulating layer containing a cured product of the resin composition according to claim 1; and
a wiring.

20. A wiring board comprising:
an insulating layer containing a cured product of the prepreg according to claim 14; and
a wiring.
